(19) United States
(12) Patent Application Publication
(10) Pub. No.: US 2008/0249761 A1
(43) Pub. Date: Oct. 9, 2008

(54) System and method for the automatic generation of grammatically correct electronic medical records

(76) Inventor: Orville E. Easterly, Granite Bay, CA (US)

Correspondence Address: James H. Salter, 105 Thoreau Lane, Folsom, CA, 95630, US

(21) Appl. No.: 11/732,604

(22) Filed: Apr. 4, 2007

(51) Int. Cl. G06F 17/28

(52) U.S. Cl. 704/3

(57) ABSTRACT

A system and method for automatically generating grammatically correct electronic medical records is disclosed. The system of an example embodiment includes an input component to receive an input from a user, to map the input to a corresponding sentence fragment, and to retrieve a sentence identifier corresponding to the input. The system further includes an output component to locate the sentence identifier in an output template, and to insert the sentence fragment in the output template at a location indicated by the sentence identifier.

### BACKGROUND

1. Copyright

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2006-2007, Orville Easterly. All Rights Reserved.

2. Technical Field

Embodiments relate to the field of data processing. Specifically, various embodiments relate to data processing for electronic medical records.

3. Related Art

Internet research reveals that other companies and organizations, beginning with Mayo Clinic in 1968, have attempted to design and build a computer-patient interview software application that would produce a chart ready patient medical history. To date, these attempts have fallen short of the quality required in order to be accepted across the medical community. There are at least five companies on the Internet that claim to have some form of a computer-patient interview application. The technology offered by each of these companies is described below.

PrimetimeMedical Software in Columbia, S.C. (www.medicalhistory.com) describes their computer-patient interview software as follows; “Branching logic enables patients to progress quickly through adjustable questionnaires from an extensive medical knowledgebase. Sophisticated technology enables this information to transfer to Electronic Medical Records (EMR's). Physician productivity increases because as much as sixty percent of the medical data necessary to complete the visit note can be provided by patients and automatically documented in medical terminology through the Internet, in exam rooms, or in waiting areas before the encounter.” PrimetimeMedical Software technology uses “adjustable questionnaires” similar to the questionnaires that the patient currently completes in the physician's waiting room. The physician must then interview the patient to obtain the additional forty percent of the medical data necessary to write or dictate the chart note for that visit.

Kryptiq (www.kryptiq.com) markets a computer-patient interview technology called, CareCatalyst™ Patient Portal. Their web site states that their Patient Portal allows patients to directly input patient information into their physician's Electronic Health Record (EHR) with customizable eForms over the web and to request prescription refills/renewals and appointments online.

RelayHealth (www.relayhealth.com) markets a product called a webvisit. This is an online consultation that is routed directly to a doctor or to his nurse and to which the doctor can then respond. The consultation adapts to the patient's responses; so if a patient answers a question a certain way, his next questions may reflect his previous answer. RelayHealth's webvisit technology is basically email interaction with the patient's physician.

MedicalNetSystems (www.medicalnetsystems.com/) website explains that their TurboHX collects the patient's history in two phases, the patient generated medical history (PGMH) and the physician's editing. “In the PGMH module, the patient develops his or her medical history. The health care provider reviews and edits the patient's history through TURBOHX's edit module.” MedicalNetSystems' product does not produce a chart ready comprehensive patient medical history that is professionally written in the vocabulary and syntax of a physician. Their TURBOHX product requires that the physician edit the patient's data entry and put it in chart ready content and format.

Thus, a system and method for automatically generating grammatically correct electronic medical records is needed.

### BRIEF DESCRIPTION OF THE DRAWINGS

Embodiments are illustrated by way of example and not limitation in the figures of the accompanying drawings, in which:

FIG. 1 is an example implementation of the system and method of an example embodiment.

FIG. 2 is an operational flow diagram illustrating a series of steps in using an example embodiment.

FIG. 3 is a diagram illustrating an example of a comprehensive, “patient specific” medical history or initial consultation report in an example embodiment.

FIG. 4 illustrates an example of the chief complaint portion and the history of the present illness portion of an example medical record.

FIG. 5 illustrates the history section of an example report extract as partitioned into sentence fragments.

FIG. 6 illustrates a mapping between user inputs and corresponding sentence fragments.

FIG. 7 is a detail of the sentence fragments for a particular example.

FIGS. 8A and 8B are examples of a sample spreadsheet illustrating an example of an input template in one embodiment.

FIGS. 9A, 9B, and 9C are examples of an extract of an output template in one embodiment.

FIGS. 10A-10C and 11A-11G are examples of an input template for the example of one embodiment.

FIG. 12 illustrates a mapping between user input and a corresponding sentence fragment along with a detail of the sentence fragment for a particular example.

FIG. 13 illustrates a mapping between user inputs and corresponding sentence fragments.

FIG. 14 is an example of an input template for the example of one embodiment.

FIG. 15 is a detail of the sentence fragments for a particular example.

FIG. 16 illustrates a mapping between user inputs and corresponding sentence fragments.

FIG. 17 is a detail of the sentence fragments for a particular example.

FIG. 18 illustrates a mapping between user inputs and corresponding sentence fragments.

FIG. 19 is a detail of the sentence fragments for a particular example.

FIG. 20 illustrates a mapping between user input and a corresponding sentence fragment along with a detail of the sentence fragment for a particular example.

FIGS. 21-23 illustrate an example embodiment of a computing system in accordance with the disclosed subject matter.

FIG. 24 is a flow diagram illustrating a processing flow in a particular embodiment.

### DETAILED DESCRIPTION

A system and method for automatically generating grammatically correct electronic medical records is disclosed. In the following description, numerous specific details are set forth. However, it is understood that embodiments of the various embodiments may be practiced without these specific details. In other instances, well-known processes, structures and techniques have not been shown in detail in order not to obscure the understanding of this description.

The various example embodiments described herein provide a capability for automatically generating grammatically correct electronic medical records. In particular, various embodiments provide a system and method for leading a patient through an interview which produces a comprehensive, “patient specific” medical history, which is professionally written in the vocabulary and syntax of physicians. The resultant history is “chart ready” and capable of being downloaded to the physician's computer prior to the actual evaluation. The history can then be amended, edited and expanded by the physician as needed. Additionally, once the physical examination is complete the results of that examination are added. The history and physical examination then become part of the patient's permanent medical record.

The system of an example embodiment includes an input component to receive an input from a user, to map the input to a corresponding sentence fragment, and to retrieve a sentence identifier corresponding to the input. The system further includes an output component to locate the sentence identifier in an output template, and to insert the sentence fragment in the output template at a location indicated by the sentence identifier. Further details in an example embodiment are provided below.

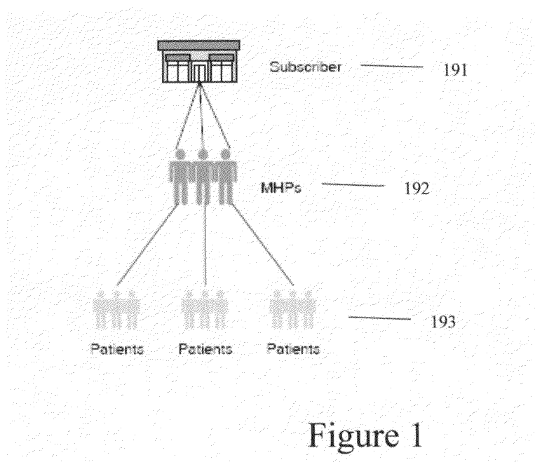

Referring to FIG. 1, an example embodiment of the system and method of an example embodiment is illustrated. In one embodiment, a web-based interface and online application is used by a patient for the input of information related to the patient's medical condition. The web site and online application may be targeted to physicians, surgeons and mental health professionals to assist them in producing a patient's medical and mental health history.

Currently, medical and mental health professionals (MHPs) interview patients and then manually create a medical or mental health history, a time-consuming and costly process. In essence, the web-based interface and online application of a particular embodiment replaces this conventional process by allowing patients to visit the inventive web site to complete an online computer-patient interview.

The web-based interface and online application of a particular embodiment captures patient responses to a series of statements and then produces a comprehensive “chart ready” medical or mental health history or record based on those responses as will be described in more detail below. Note that the medical record generation technology described herein can be applied to the generation of medical, surgical, hospital, mental health, counseling, coaching, physical therapy, mental therapy, behavioral therapy records, or other similar types of medically-related records and documents. The term, “medical record” as used herein includes all forms of these medically-related records.

The web-based interface and online application of various embodiments differs from conventional online computer-patient interview software in that the “chart ready” report is “patient specific” and written in complete sentences in the vocabulary and syntax of a dictating physician. The reports of other conventional computer-patient interview software are “patient generic” using one word or incomplete sentences that do not identify the unique medical experience of the patient, but rather applies to any patient selecting the same response or series of responses. The “chart ready” and “patient specific” report of particular embodiments is the real end product of the web site and online application.

Subscriber: Referring to FIG. 1, a subscriber 191 will register with the web site of a particular embodiment and purchase a subscription to the software of a particular embodiment from an online e-commerce store, agree to the user license, edit subscriber information and access and print reports generated by the online software. In addition, subscribers will also be able to download patient medical and mental health histories to their local computer in a conventional CSV file format. Some subscribers will have multiple MHPs 192 within their organization. Subscriber will be able to input MHP personal contact information and the application will assign a unique identifier to each MHP 192.

MHP: Medical or mental health professionals 192 are members of the professional staff in the subscribers' offices. MHPs will be provided with a unique identifier within the online database.

Patient: The patient 193 is the true end-user of the online application of various embodiments. The patients 193 may fill in personal contact and demographic information and respond to a series of medically-related statements and questions. Patients will be provided a unique identifier from the MHP 192, and will be asked to create a username and password to access the system. By entering the identifier received from the MHP 192, the MHP's information can be inserted into the final report. By entering the username/password, the patient 193 can “save” progress in the entry of the patient's medical information, exit the system and return later to complete the questionnaire. In addition, once the patient 193 completes the questionnaire and confirms completion, the unique username/password assigned to the patient 193 will be “locked,” disallowing the patient 193 to revisit the questionnaire without a new username and password being created.

Definition of Patient Specific: The medical history report automatically created by particular embodiments described herein is written specifically about the patient who completes the online computer-patient interview, in the vocabulary and syntax of a dictating physician, using complete grammatically-correct sentences with adjectives and adverbs which describe the patient's unique medical experience and/or condition. Lists are used when appropriate to present certain behaviors and symptoms that are unique to the patient.

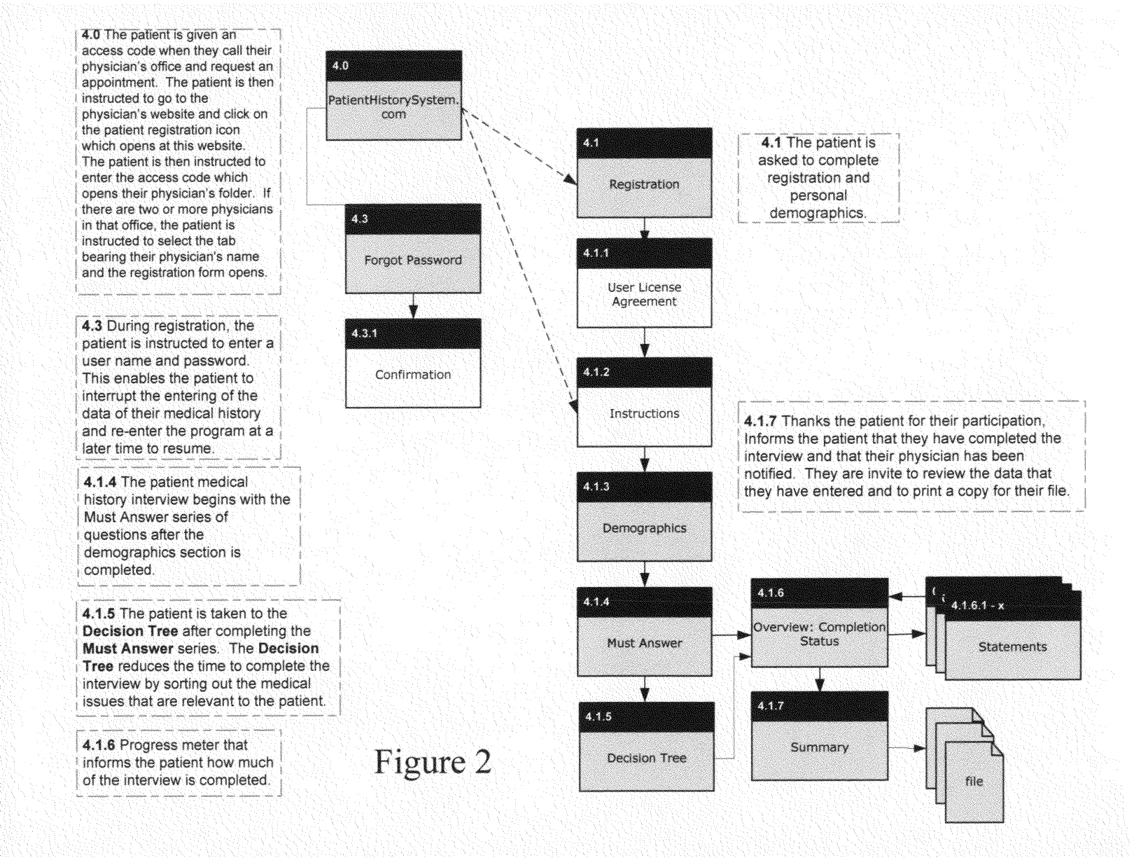

Referring to FIG. 2, an operational flow diagram illustrates a series of steps in using an example embodiment. Initially in step 4.0, the patient is given an access code when they call their physician's office and request an appointment. The patient is then instructed to go to the physician's website and click on the patient registration icon which opens at this website. An embodiment of the present invention can be implemented to execute when this patient registration icon is clicked by a user. The patient is then instructed to enter the access code which opens their physician's folder. If there are two or more physicians in that office, the patient is instructed to select the tab bearing their physician's name and the registration form opens.

In step 4.3 during registration, the patient is instructed to enter a user name and password. This enables the patient to create a system interaction session. Such a session is maintained after user logout and may be continued at a subsequent login. In this manner, a patient can interrupt the entering of the data of their medical history and re-enter the program at a later time to resume data entry.

In step 4.1.4, the patient medical history interview begins with the Must Answer series of questions after the demographics section is completed. This part of the on-line interview process of an example embodiment enables the patient to tell their physician the primary reason for this appointment (e.g. the reason for the patient's interaction with the on-line medical interview system). The patient is prompted to select a system or location of their body that is causing them some concern. When the patient selects the system of their body where their primary symptom is located, processing control is directed to the section called Chief Complaint where the patient can choose their primary symptom. When the patient chooses their Chief Complaint, they are taken to the section called History of Present Illness where they respond to a series of statements that enable them to describe the origin and development of their present illness or condition. The next screen that opens is a Review of Systems. In this section, the patient tells the physician about any additional symptoms that they are experiencing. Each of these patient queries are described in detail in the examples presented below.

In step 4.1.5, processing control is directed to the Decision Tree where the patient is prompted to provide their Past Medical History, which may or may not be part of the cause of the patient seeing their physician this visit. The past medical history provides the physician with a detailed description of all medical issues in the patient's past. This medical history is provided/entered by the patient her/himself. The Decision Tree reduces the time to complete the interview by sorting out the medical issues that are relevant to the patient.

In step 4.1.6, a progress meter is displayed to inform the patient about how much of the interview is completed. In step 4.1.6.1 and as described in more detail below, the system of various embodiments maintains the statements and choices to which the patient responds while working through the Must Answer series and the Decision Tree.

In step 4.1.7, The Summary contains: a statement of our appreciation for the patient's participation, the patient is informed that they have completed the interview and that their physician has been notified. The patient is invited to review the data that they have entered and to print a copy for their file.

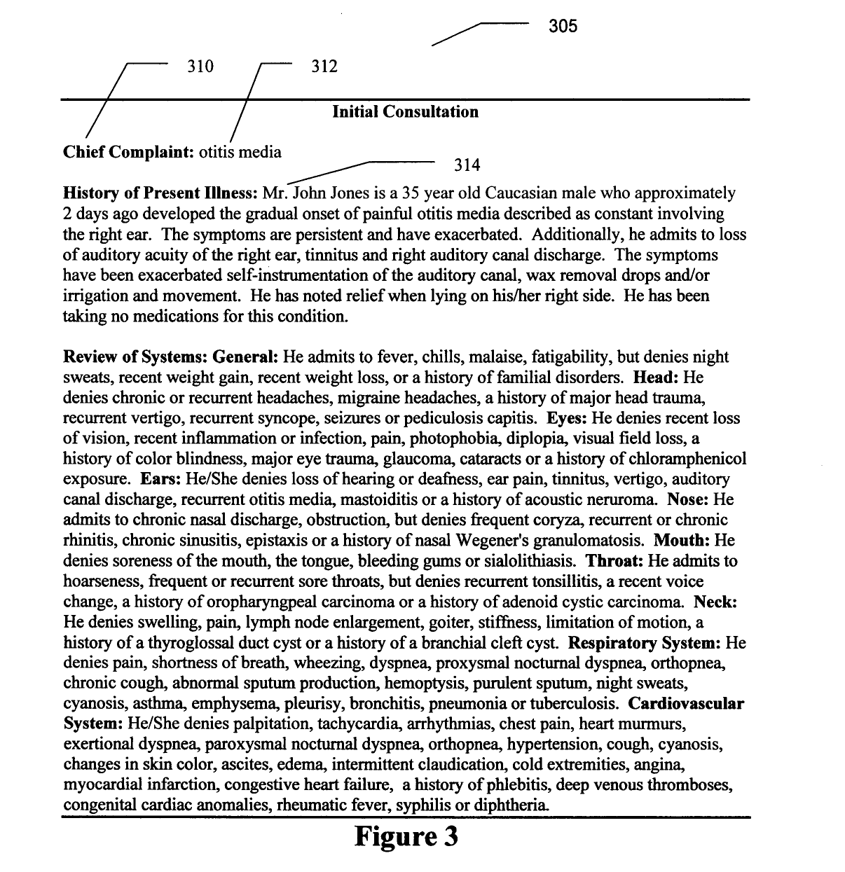

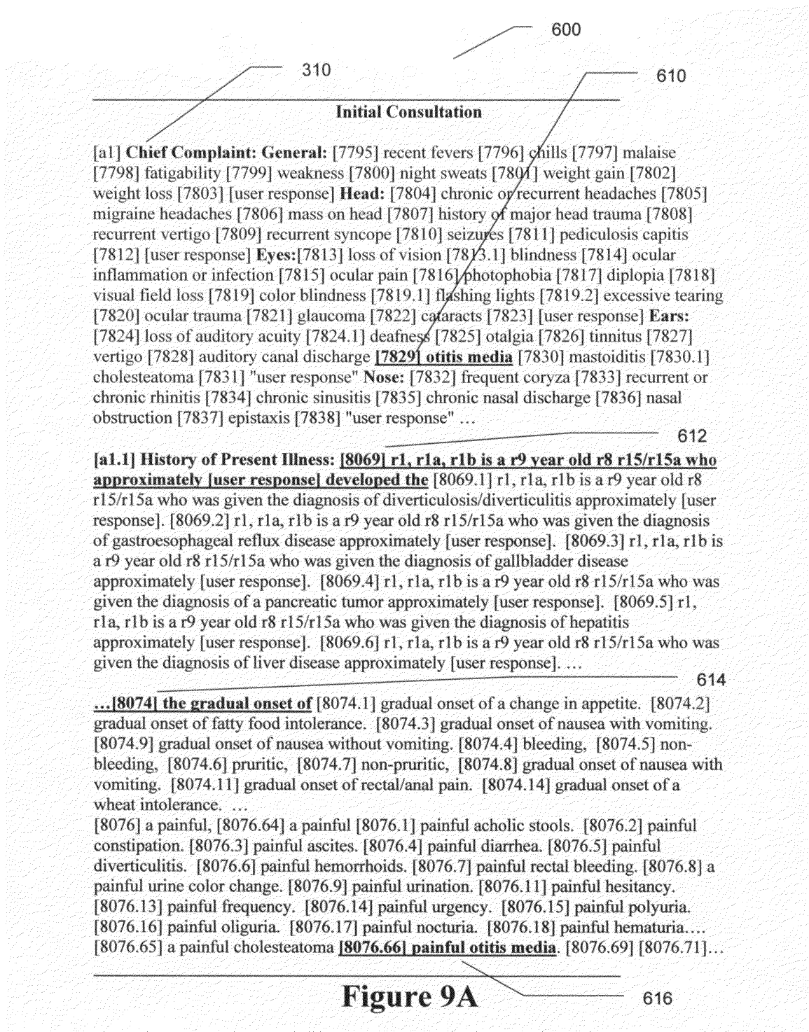

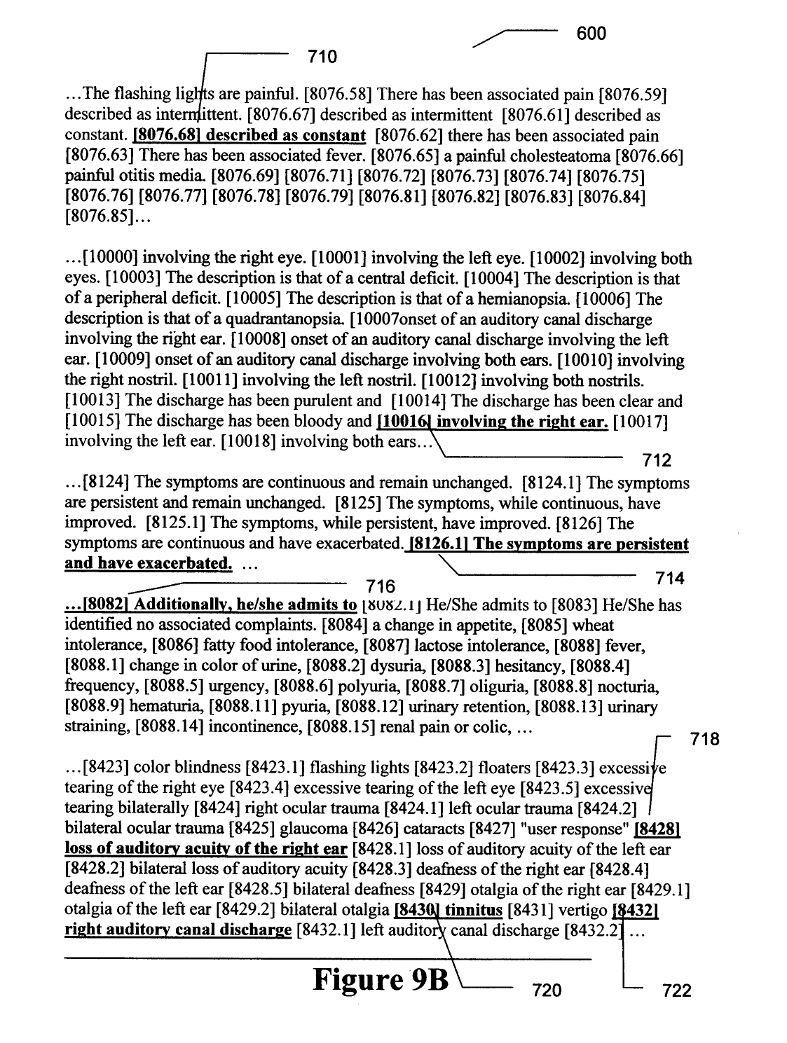

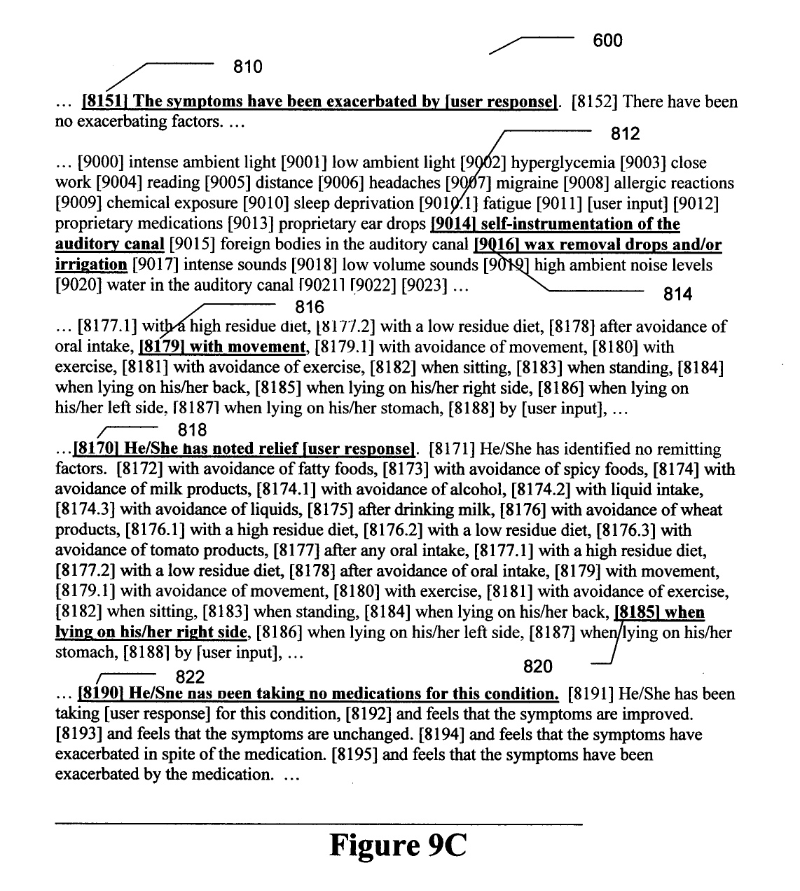

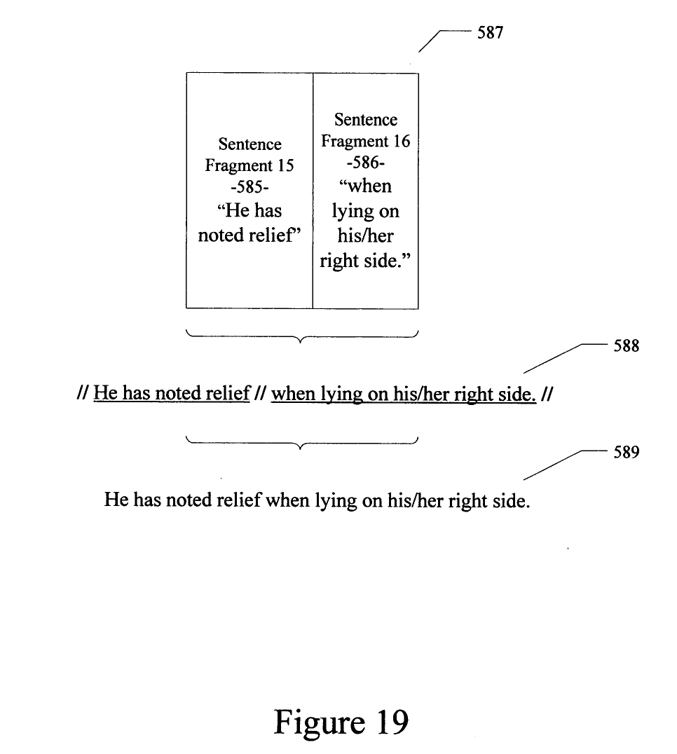

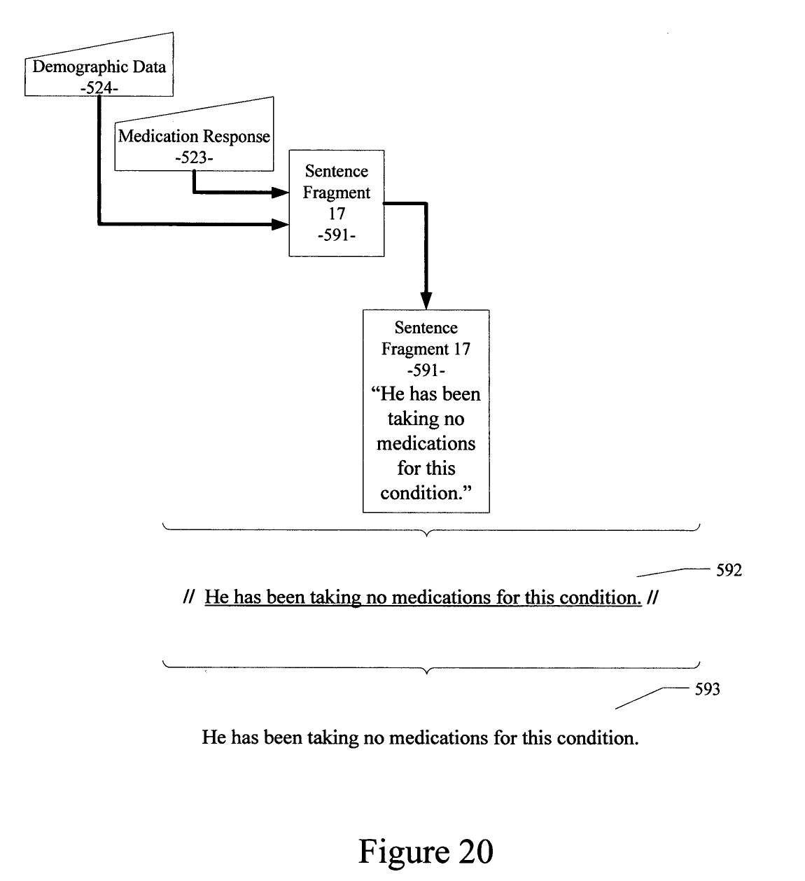

Referring now to FIG. 3, a diagram illustrates an example of a comprehensive, “patient specific” medical history or initial consultation report 305 (also referred to herein as the medical record), which is professionally written in the vocabulary and syntax of physicians as produced by an embodiment of the present invention. The resultant medical record 305 is “chart ready” and capable of being downloaded to the physician's computer prior to the actual evaluation of the patient. This medical record 305 is automatically produced by an embodiment in response to various inputs provided by a patient via a web-based user interface as will be described in more detail below. In this example of a medical record 305, the chief complaint 310 and the history of the present illness 314 are automatically generated by an embodiment in a particular format as defined in a report template 600 (also referred to herein as an output template), an example of which is shown in FIGS. 9A-9C. As will be described in more detail below in a particular example, input provided by a patient/user is mapped to sentence fragments. The sentence fragments are then placed in the medical record 305 at a location defined by the report template 600. Any portion of medical record 305 and any format of medical record 305 can be produced in this manner. A particular example of the automatic production of the comprehensive and “patient specific” medical record 305 is illustrated in FIGS. 3-20 and described in detail below.

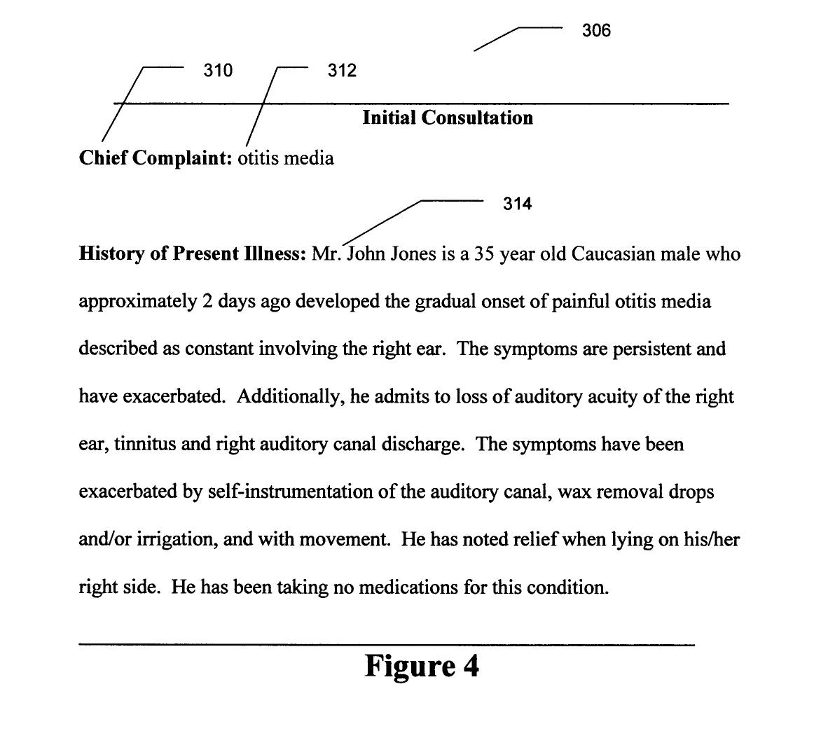

Referring now to FIG. 4, the chief complaint 310 portion and the history of the present illness 314 portion of medical record 305 from the example of FIG. 3 are reproduced. Based on patient input, an embodiment has inserted the phrase, “otitis media” 312 following the “Chief Complaint” header 310 in medical record 305. The patient has identified this medical condition as his/her chief medical complaint. In the, “History of Present Illness” section, an embodiment has produced grammatically-correct sentences that provide a comprehensive and patient-specific description of the patient based on the patient's responses to various questions prompted by an embodiment.

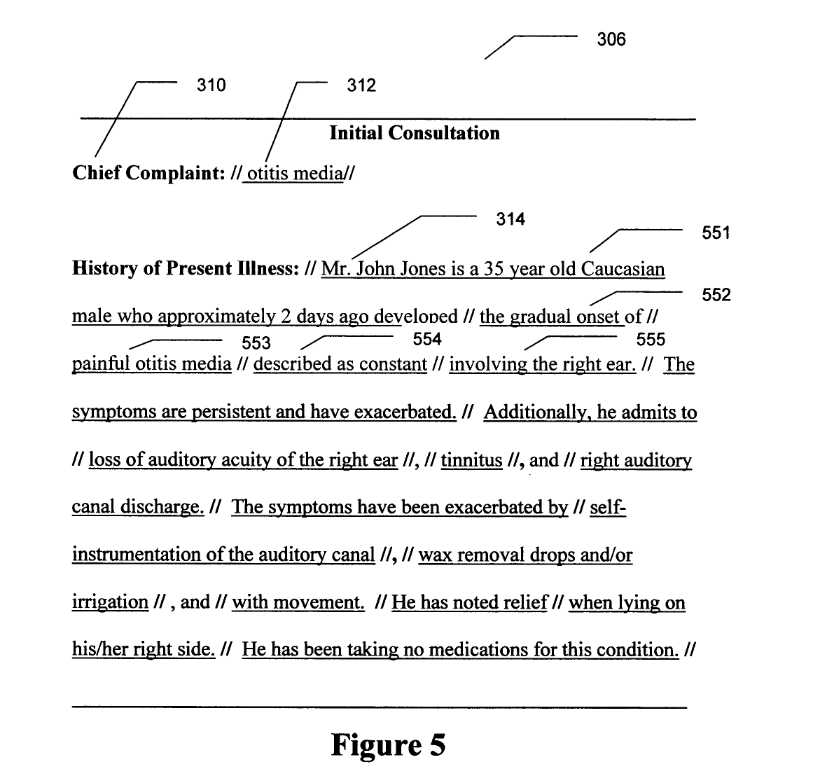

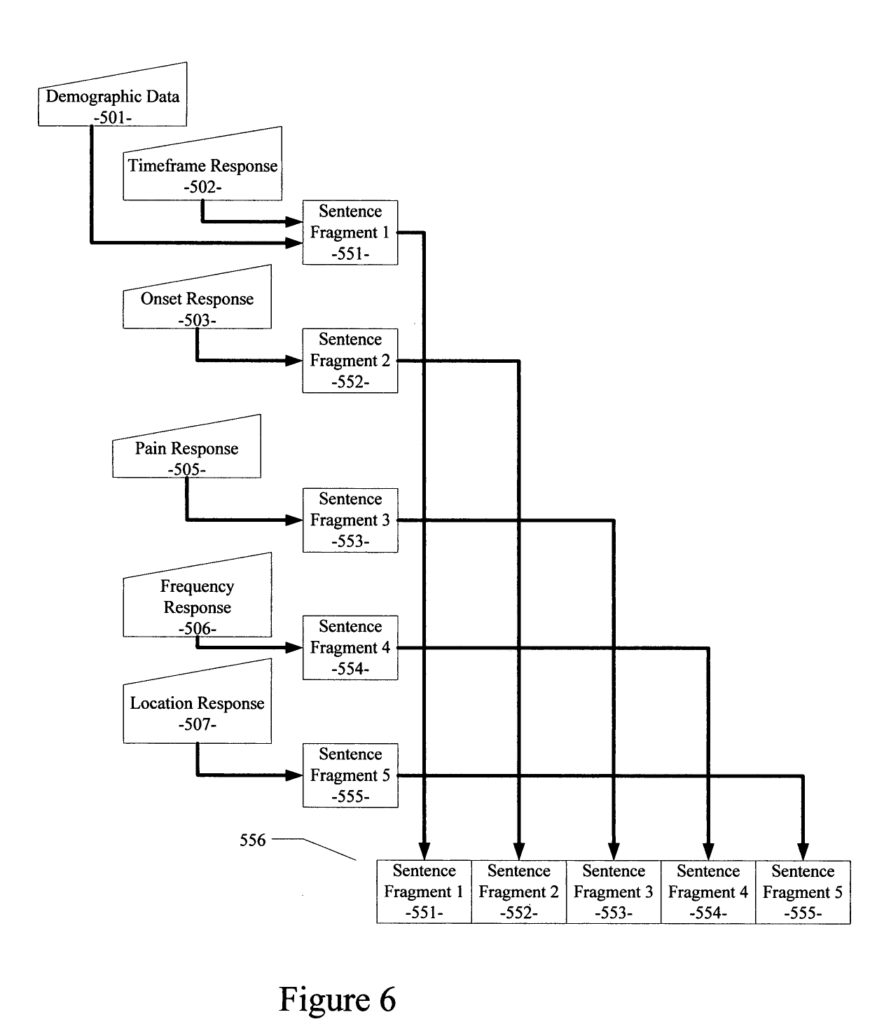

Each of the sentences shown in the history section 314 of report extract 306 can be composed of one or more sentence fragments. Each sentence fragment can be associated with one or more particular inputs provided by the patient via the web-based interface. FIG. 5 illustrates the history section 314 of report extract 306 as partitioned into sentence fragments, each fragment being shown between the “//” symbol. It will be apparent to those of ordinary skill in the art that the sentences of history section 314 could be differently but equivalently partitioned. For example, the first sentence of history section 314 is composed of five sentence fragments, 551-555. First sentence fragment 551 is composed of a set of demographic information (i.e. name, age, race, gender, etc.) that may be automatically extracted from the demographic information input by the patient. The sentence fragment 551 is also composed of timeframe information (i.e. “approximately 2 days ago”). This timeframe information is obtained from the patient in response to a question presented by a particular embodiment. FIG. 6 illustrates the mapping between the patient responses and the corresponding sentence fragments of the first sentence 556 of the example of a particular embodiment.

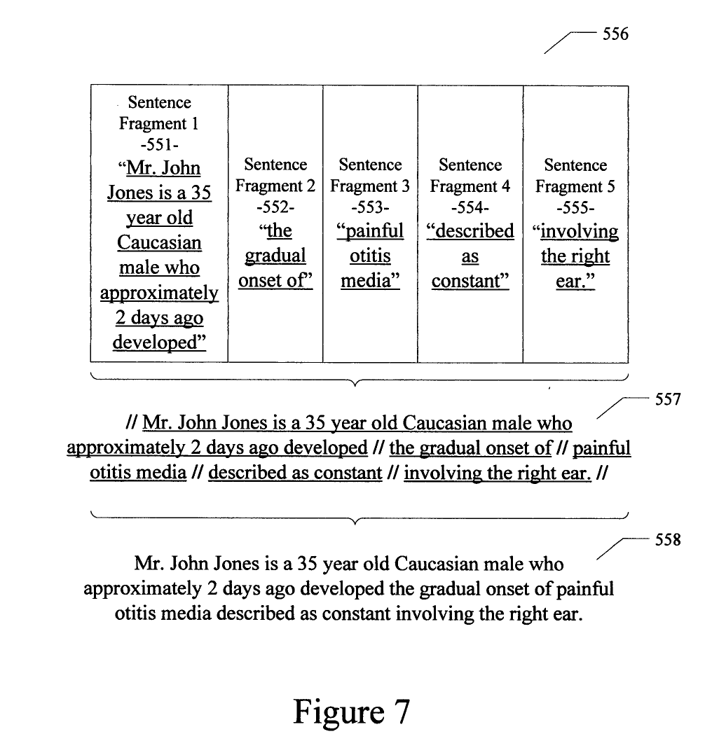

Referring now to FIG. 6, particular inputs 501-507 provided by a patient can be mapped to particular sentence fragments 551-555 and assembled into a complete sentence 556 for insertion into history section 314 of medical record 305. FIGS. 6-7 illustrate such a mapping for the first sentence of the particular example shown in history section 314 of FIGS. 4-5. Referring again to FIG. 6, demographic information 501 and a timeframe response 502 provided by the patient via the web-based interface is used to automatically create sentence fragment 551. This sentence fragment 551 is detailed in FIG. 7.

Although demographic information 501 can be captured and extracted using conventional techniques, patient responses 502-507 are patient-specific responses to particular medical questions presented by a particular embodiment. The presentation of these medical questions and the processing of the patient responses is detailed next.

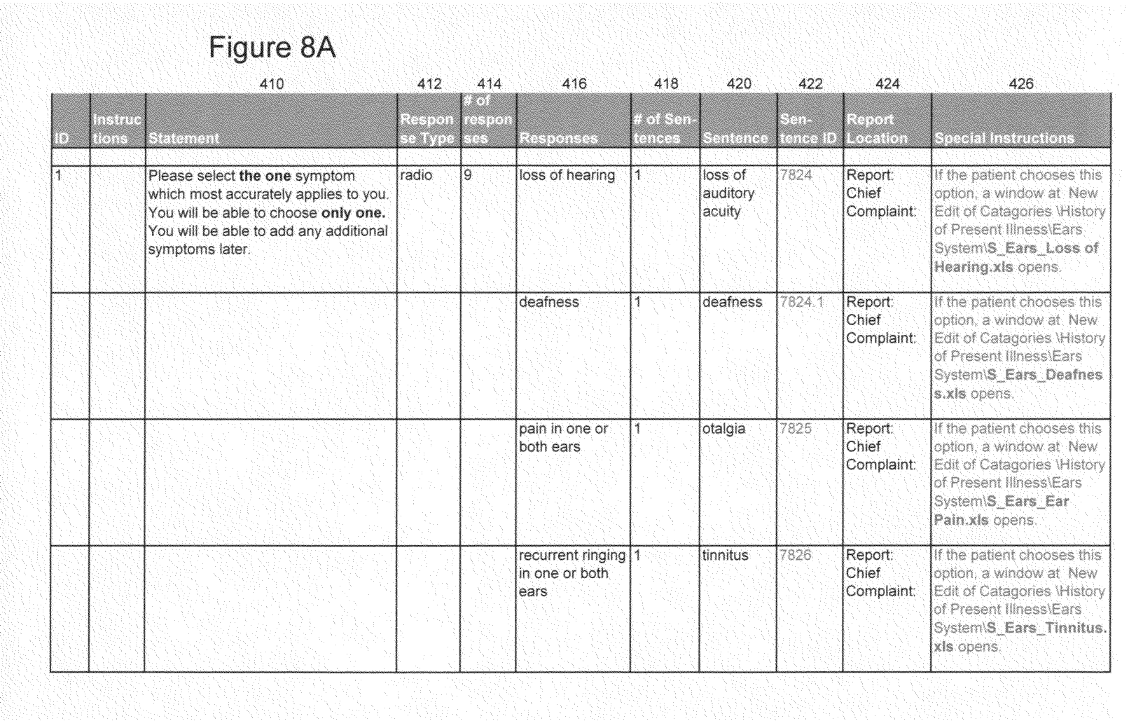

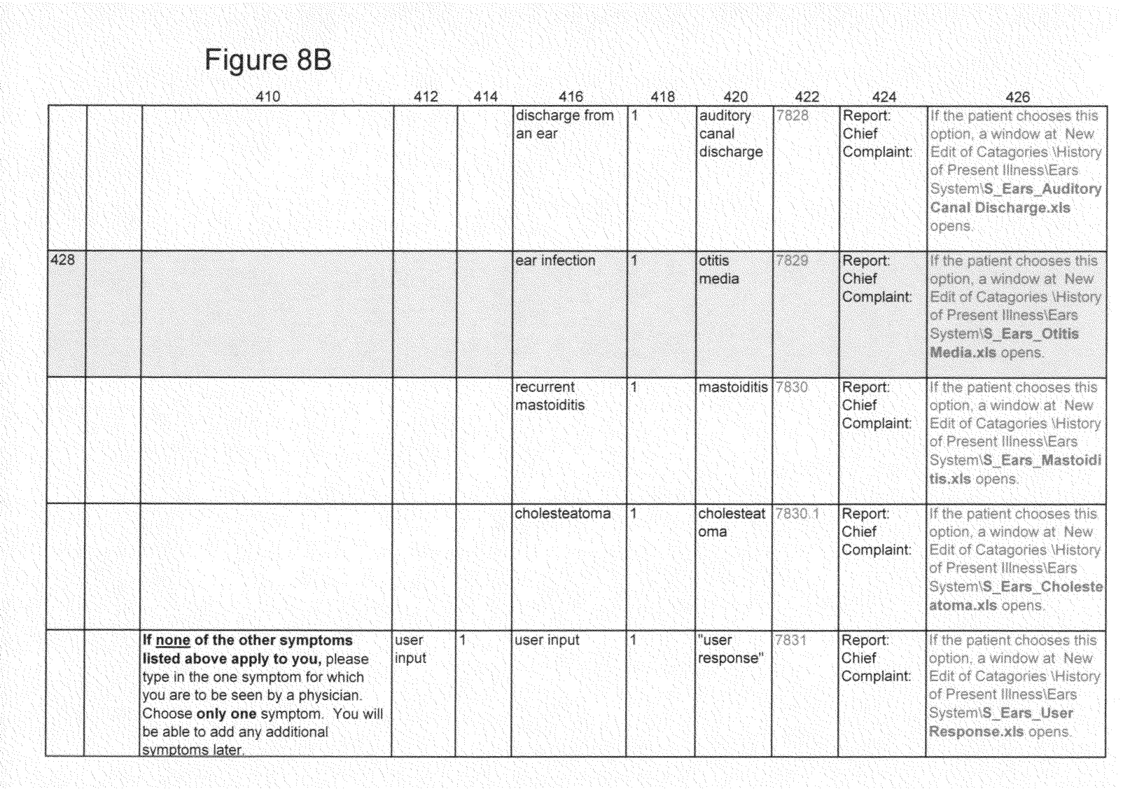

Referring now to FIGS. 8A and 8B, a sample spreadsheet illustrates an example of an input template in one embodiment. In a column 410 of the input template, one of the medical questions presented by a particular embodiment is shown. In this case, the patient is prompted to select a medical symptom that best applies to the patient. In this example, the patient is given a set of nine response options (as defined in column 414 in FIG. 8A), which are provided as radio buttons on the web-based interface as defined in column 412 in FIG. 8A. Each of the nine response options are listed in column 416. The sentence or sentence fragment that corresponds to each response option is listed in column 420. Because a response option can be mapped to more than one sentence or sentence fragment, a value in column 418 specifies the quantity of sentences or sentence fragments that correspond to each response option. Thus, for the example shown in FIG. 8A, if a patient selected the first response option (i.e. “loss of hearing”) from column 416, the corresponding sentence fragment, “loss of auditory acuity” from column 420 will be automatically inserted into the patient's medical record 305. In this manner, patient responses can be mapped to a corresponding sentence(s) or sentence fragment(s) that is professionally written in the vocabulary and syntax of physicians. The sentence identifier (ID) provided in column 422 for each response option as shown in FIG. 8A is used to uniquely identify the specific location in the medical record 305 where the mapped sentence(s) or sentence fragment(s) should be automatically placed. Column 424 defines one or more reports or portions of the patient's medical record where the sentence(s) or sentence fragment(s) should be automatically placed. Column 426 can be used to specify a link to which the input engine of a particular embodiment transitions when the corresponding response option is selected by the patient. For example, the link target defined in column 426 can specify a set of follow-on questions that relate to the corresponding response option selected by the patient. In the particular embodiment shown in FIG. 8A, the link in column 426 specifies a particular spreadsheet file to open to produce the set of follow-on questions that relate to the corresponding response option previously selected by the patient. It will be apparent to those of ordinary skill in the art that the link specified in column could also be a hyperlink, a file name, dynamic link library component, an IP address or other type of link to a related software component.

In the particular example provided herein, the patient has selected a response option corresponding to row 428 in FIG. 8B. In this case, the patient has identified an “ear infection” as his primary symptom in response to the question presented from column 410. In response to this selection, the functionality provided by one embodiment retrieves the corresponding sentence fragment, “otitis media” from column 420. The embodiment also retrieves: 1) the sentence ID, “7829” from column 422; 2) the report location, “Report: Chief Complaint:” from column 424 (also denoted herein as the document identifier); and 3) the link information, “History of Present Illness Ears System\S_Ears_Otitis Media.xls” from column 426 (the link information identifying a next input prompt). This information is used as described below to insert the sentence fragment “otitis media” from column 420 into the medical record 305 at a location defined by the sentence ID from column 422 and the report location from column 424.

Referring now to FIG. 9A, an example of an extract of an output template of a particular embodiment is shown. In the example embodiment, the structure of a particular output document, in this case an Initial Consultation Report, is defined by the template 600. As shown, the particular document 600 is partitioned into sections that would be expected or mandated by a subscriber, MHP, insurance company, or other healthcare professional or related organization. Within each section, one or more sentence ID's can be listed to provide an anchor point at which a corresponding sentence fragment can be inserted into the output document.

In the particular example described above, a patient had provided a response indicating a symptom corresponding to an ear infection. This response was mapped to the sentence ID, “7829” from column 422 and the report location, “Report: Chief Complaint:” from column 424 shown in FIG. 8B. As shown in FIG. 9A, the report location, “Chief Complaint:” 310 that corresponds to the patient response can be found. Further, the particular location within the specified section of the output document can be found using the sentence ID. In this particular example, the sentence ID, “7829” is located in the “Chief Complaint:” section of output document 600 at location 610. At this specific location of the output document 600, the sentence fragment “otitis media” from column 420 can be inserted. All other sentence ID's and sentence fragments corresponding to responses not selected by the patient can be automatically deleted. As a result, the sentence fragment 312 shown in FIGS. 4-5 can be automatically generated based on an input selected by a patient. In a similar manner, input templates can be used to present patient-specific questions to the patient and to map the particular patient responses to sentence fragments, sentence fragment ID's, and report locations in an output template where the sentence fragments can be inserted.

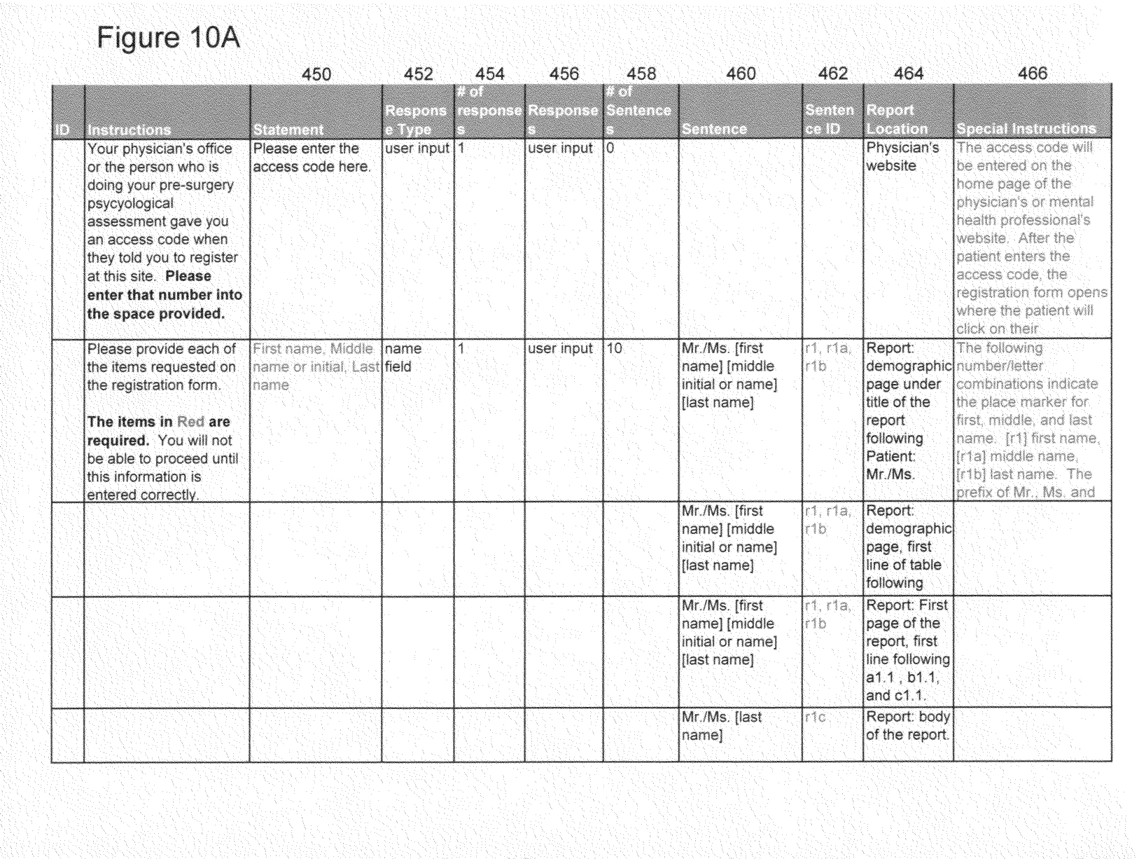

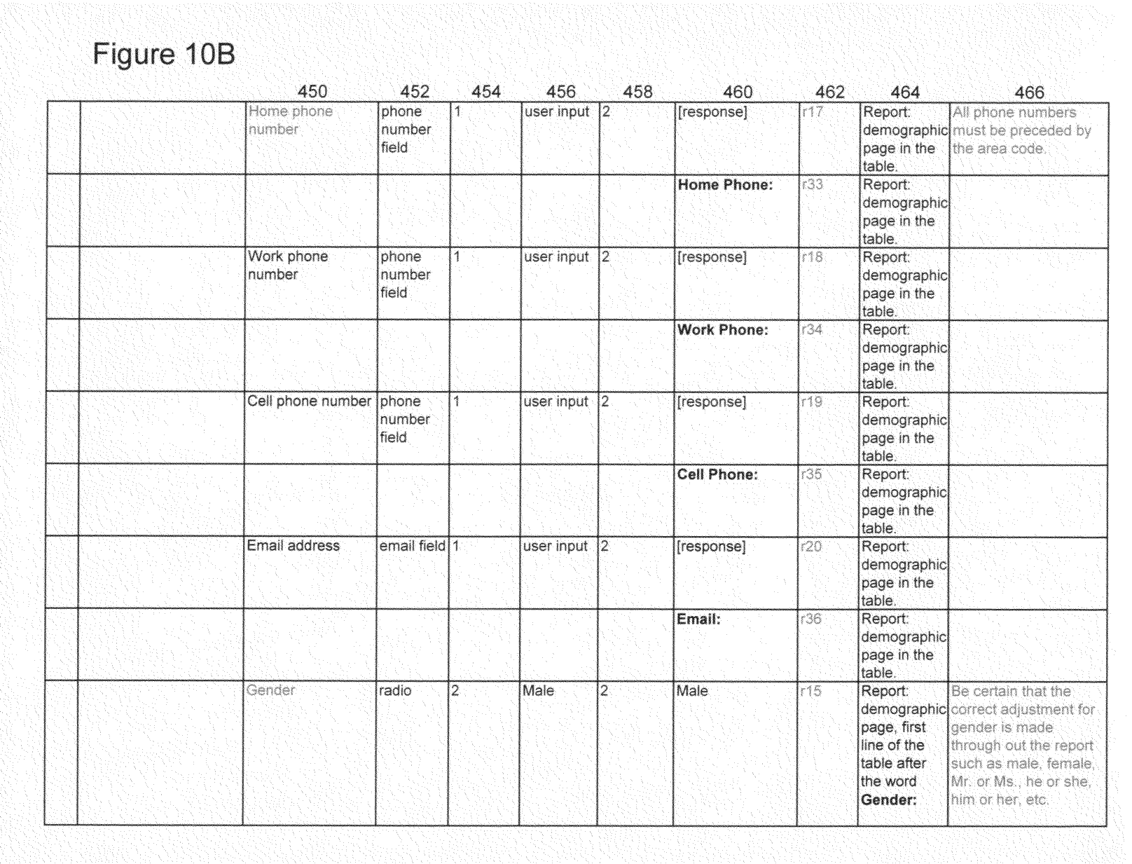

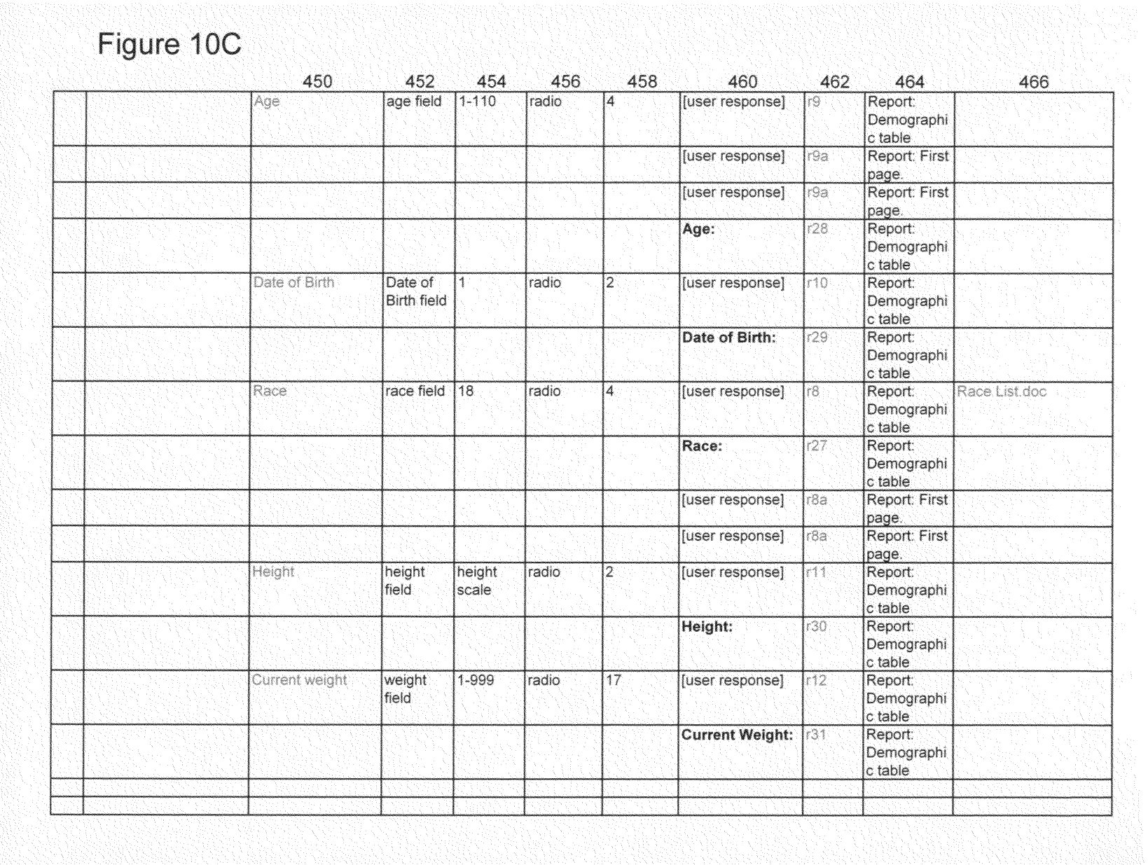

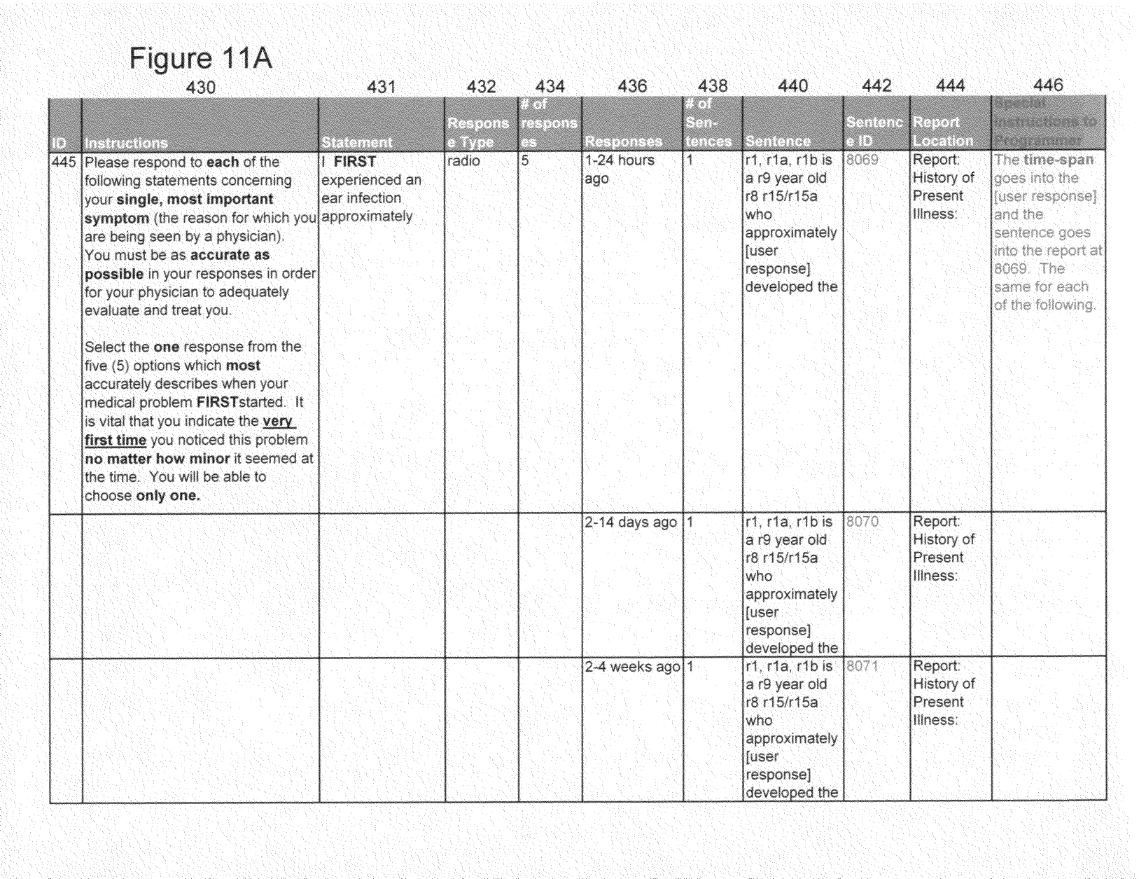

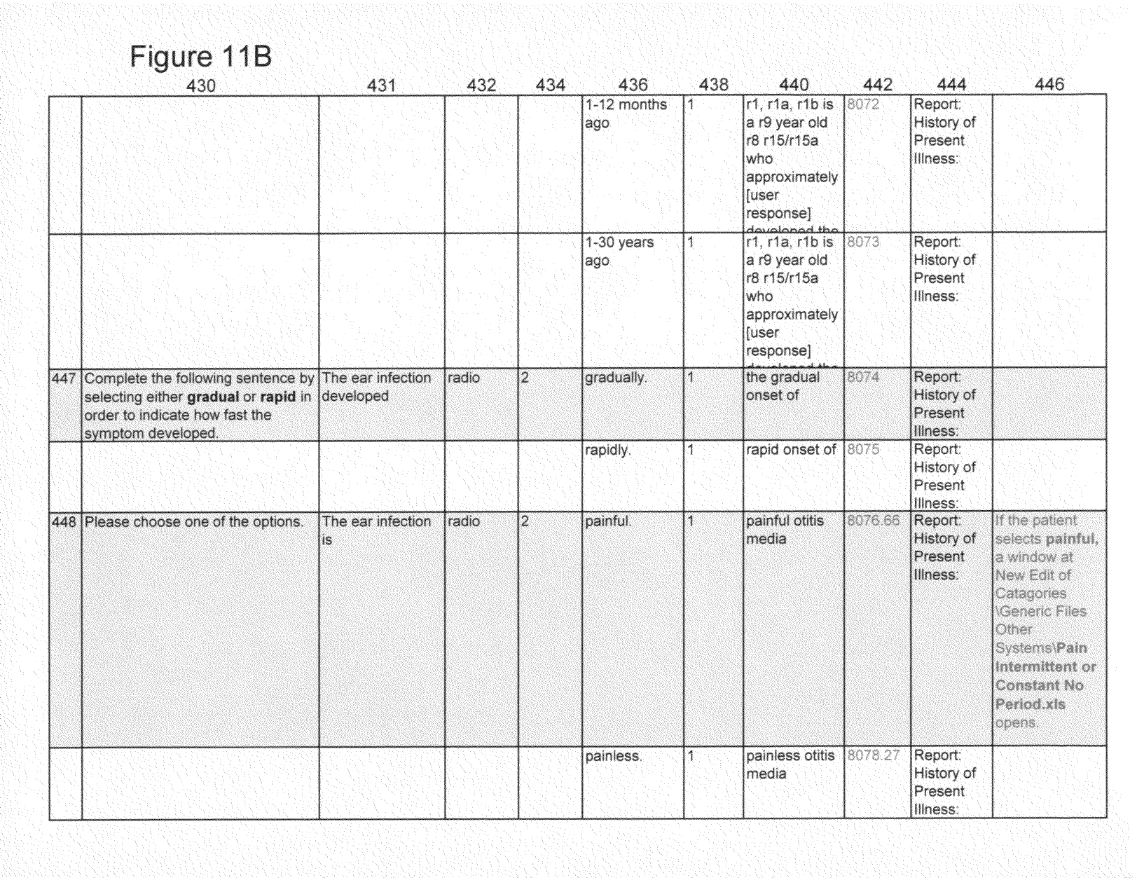

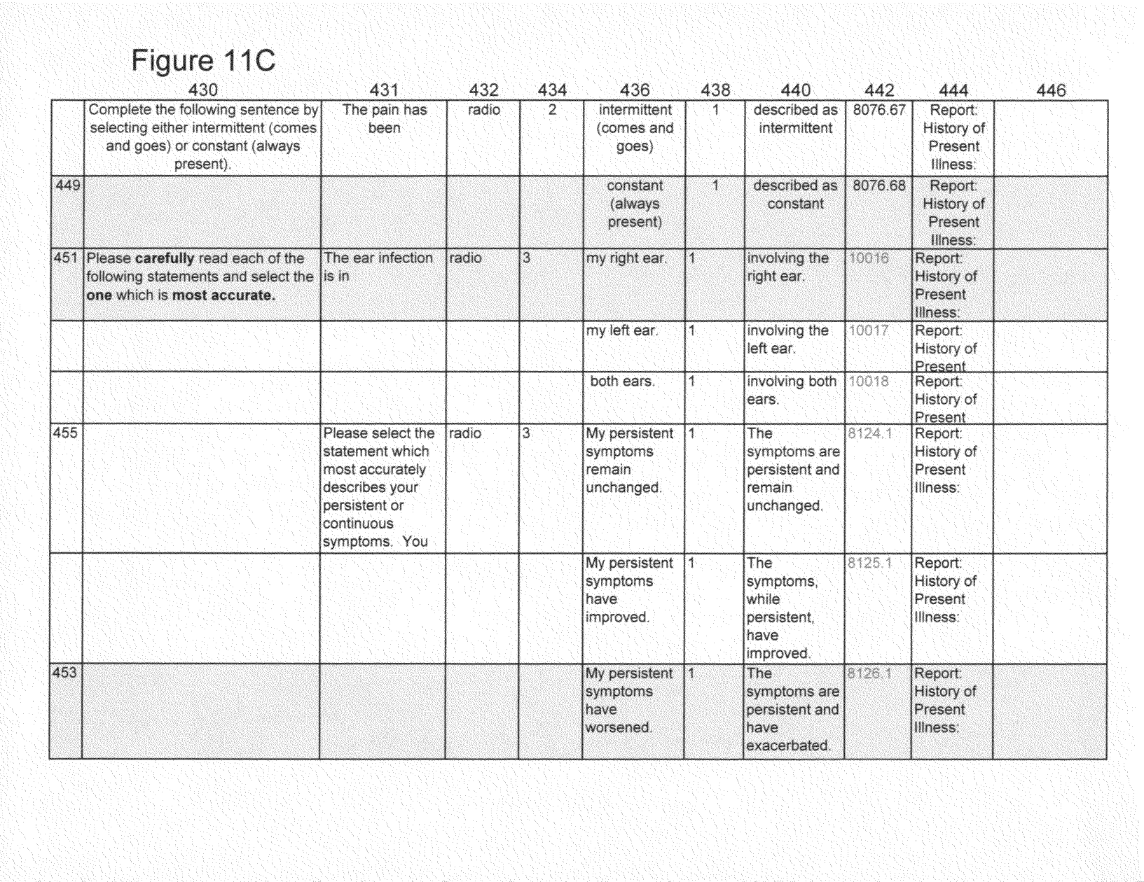

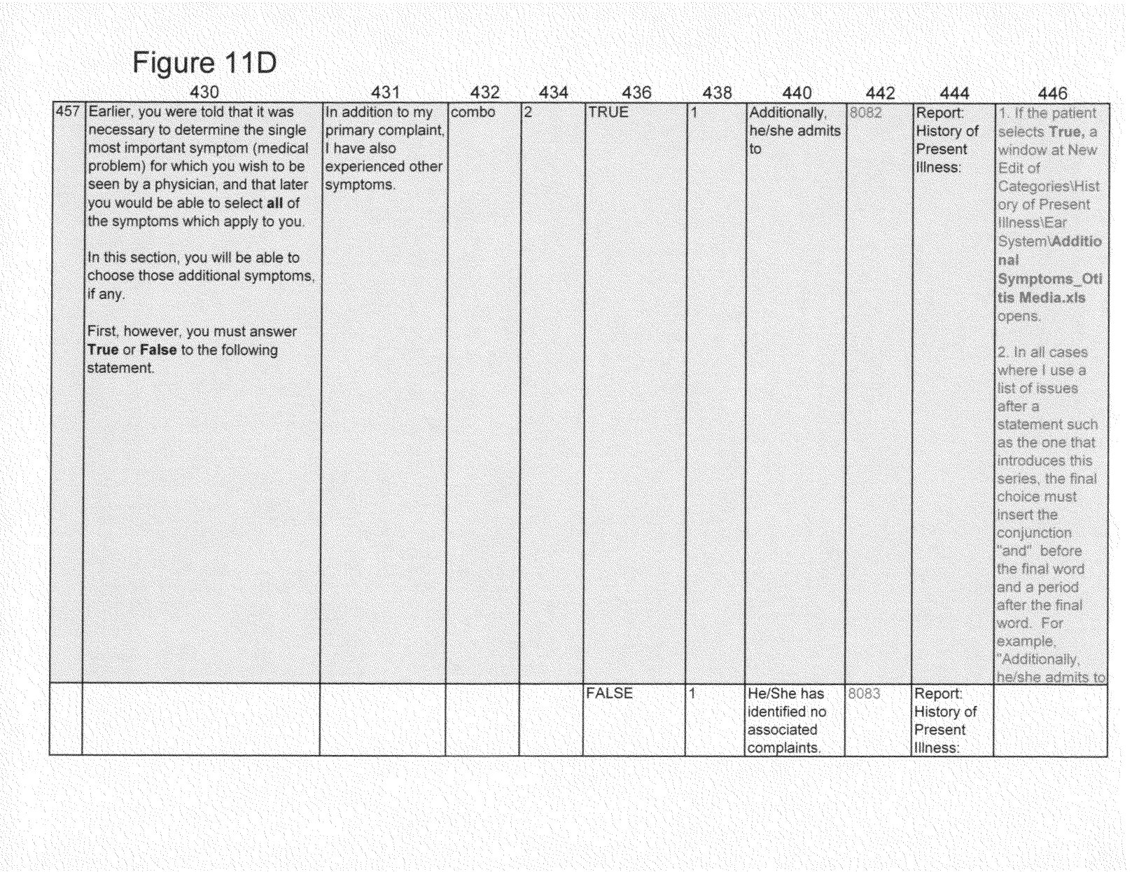

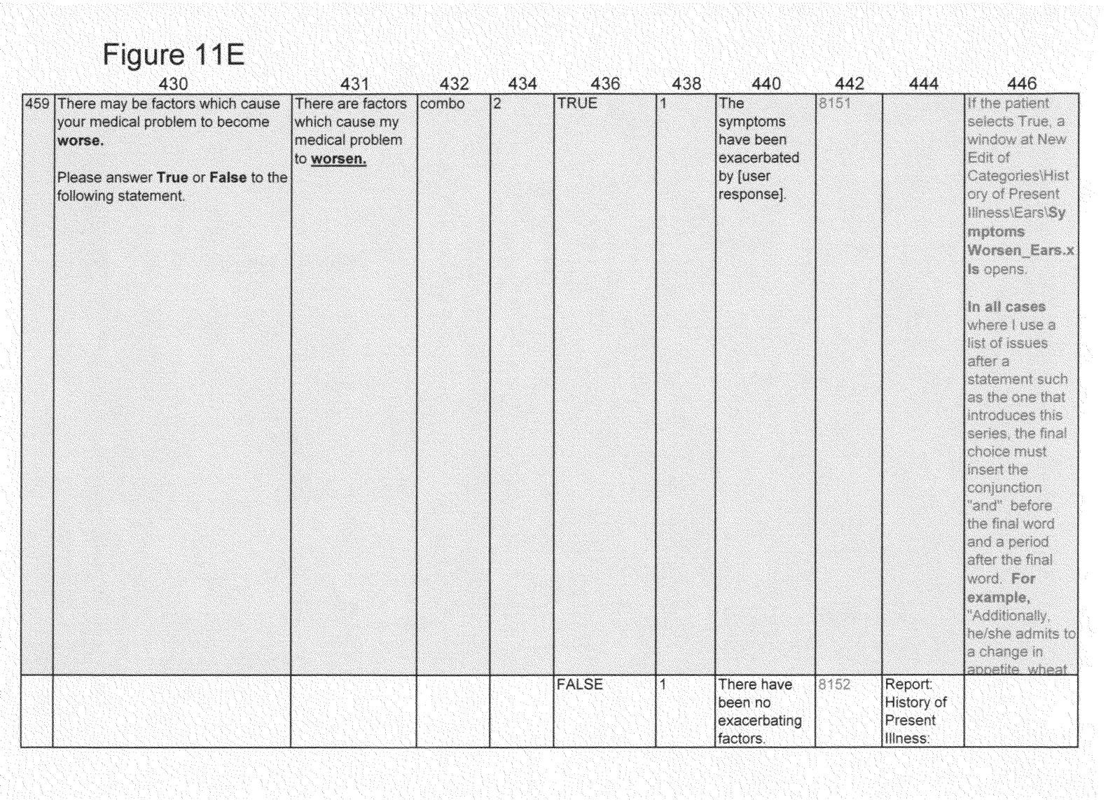

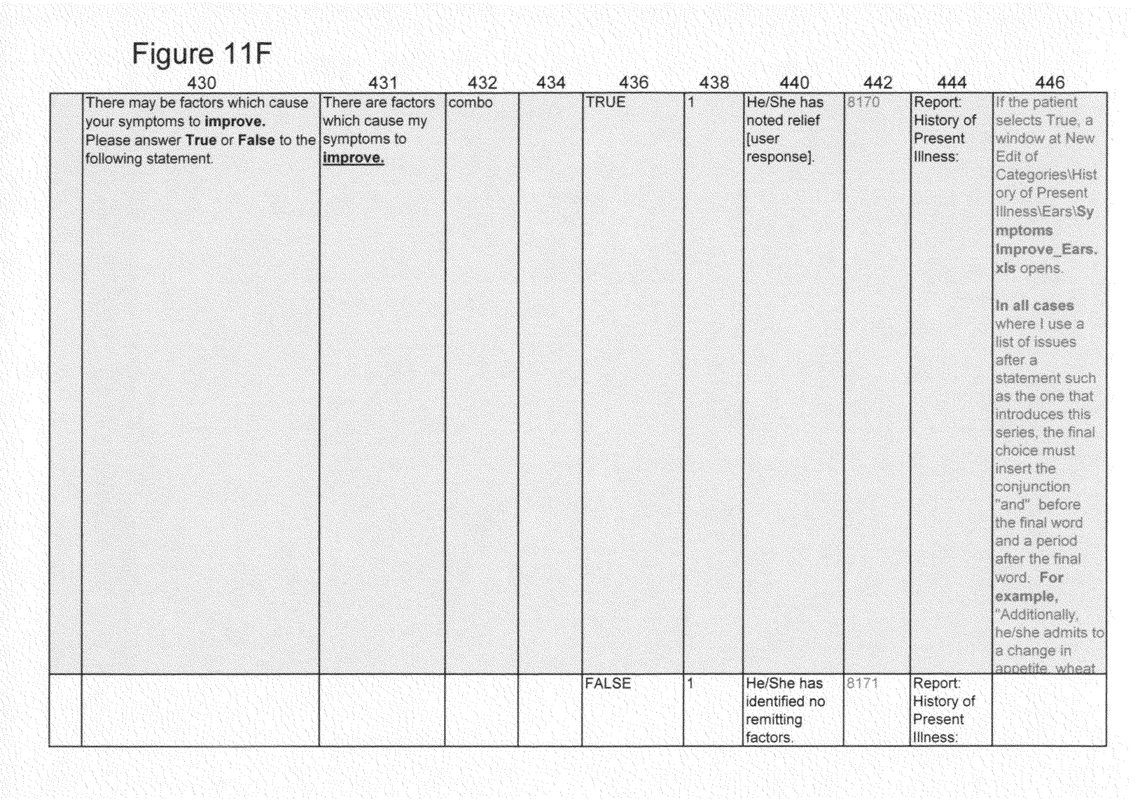

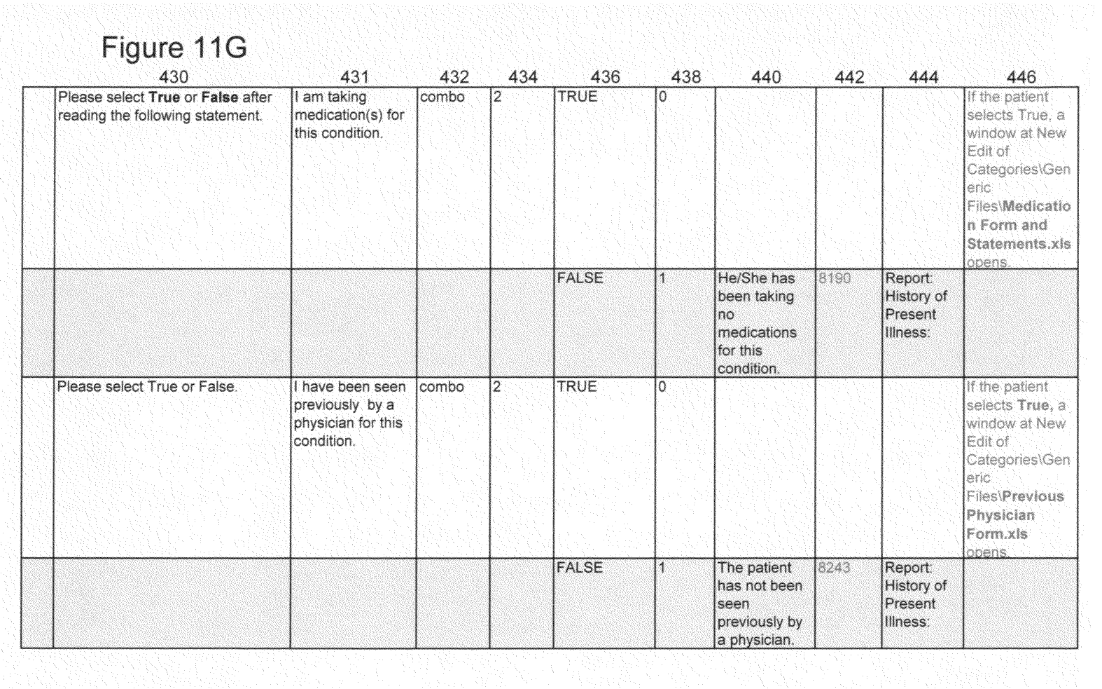

Referring again to FIGS. 6-7, the first sentence 551 of the example medical record 305 can be automatically generated in a similar manner as described above. Sentence fragment 551 of the particular example is composed of demographic data 501 and a timeframe response 502 provided by the patient/user. Referring to FIGS. 10A-10C and FIG. 11A, a input templates for this example sentence fragment 551 are shown. Referring to FIG. 11A, the patient has previously identified an “ear infection” as his/her chief complaint. Using the link associated with this response as shown in FIG. 8B at column 426, row 428 as described above, the input template shown in FIG. 11A can be obtained and used to present questions to the patient that are related to the patient's specifically identified medical complaint. In this example, the patient is presented with the instructions and the statement/question provided in columns 430 and 431 as shown in FIG. 11A. The patient is thereby prompted to enter the timeframe response 502 as needed for part of sentence fragment 551. In this particular example, the patient selects a response corresponding to a timeframe of, “1-24 hours ago” as shown in column 436 of FIG. 11A. As a result of this selection, the sentence fragment from column 440 of FIG. 11A is retrieved and inserted into the medical record 305 in the “History of Present Illness” section as identified by the information in column 444 of FIG. 11A. Further, the sentence fragment from column 440 of FIG. 11A is retrieved and inserted into the medical record 305 at the location, “8069” as identified by the sentence ID information in column 442 of FIG. 11A.

Referring now to FIG. 9A, the output template 600 is shown. In response to the patient's selection of a timeframe response 502 as described above, the “History of Present Illness” section of output template 600 as identified by the information in column 444 of FIG. 11A is located. Further, the location of the output template 600 identified by the sentence ID, “8069” as identified by the information in column 442 of FIG. 11A is found. This location is identified as location 612 in FIG. 9A. At this location 612, the sentence fragment from column 440 of FIG. 11A is inserted into the medical record 305.

The tags r1, r1a, r1b, r8, and r15/r15a of the sentence fragment from column 440 of FIG. 11A can be replaced with the demographic data 501 obtained from the patient/user at registration time. FIGS. 10A-10C illustrate a few of the input templates for the demographic data 501 of a particular embodiment. Note that the patient-entered first, middle, and last name correspond to tags r1, r1a, and r1b as shown in FIG. 10A at column 462. Similarly, the patient's race corresponds to r8 as shown in FIG. 10C at column 462. Also, the patient's gender corresponds to r15 as shown in FIG. 10C at column 462. In each of these cases, the demographic data provided by the patient can be inserted into the medical record 305 at the location identified in the input templates shown in FIG. 11A and described above.

As a result of the processing described above, the sentence fragment 551 can be inserted into the medical record 305 as part of sentence 556 shown in FIGS. 6 and 7. The generation and insertion of this sentence fragment 551 occurs in response to the patient's entry of the timeframe response 502 along with previous entry of demographic data 501. Next, the patient is prompted to enter the onset response 503. The presentation of the statements/questions related to the onset of the medical condition in this example occurs because a link in column 446 of the previously selected patient response triggers the next automatically presented question or set of questions. In this case, the input template shown in FIG. 11B at row 447 is triggered as a result of the patient's previous response.

Referring now to FIG. 11B, the patient has previously identified “1-24 hours ago” as the timeframe of the medical complaint. Using the link associated with this response as shown in FIG. 11A at column 446, row 445 as described above, the input template shown in FIG. 11B at row 447 can be obtained and used to present questions to the patient that are related to the patient's identified medical complaint. In this example, the patient is presented with the instructions and the statement/question provided in columns 430 and 431 at row 447 as shown in FIG. 11B. The patient is thereby prompted to enter the onset response 503 as needed for sentence fragment 552. In this particular example, the patient selects a response corresponding to a gradual onset as shown in column 436 at row 447 of FIG. 11B. As a result of this selection, the sentence fragment 552, “the gradual onset of” from column 440 at row 447 of FIG. 11B is retrieved and inserted into the medical record 305 in the “History of Present Illness” section as identified by the information in column 444 of FIG. 11B. Further, the sentence fragment 552 from column 440 at row 447 of FIG. 11B is retrieved and inserted into the medical record 305 at the location, “8074” as identified by the information in column 442 at row 447 of FIG. 11B. The insertion of sentence fragment 552 occurs at the location, “8074” as identified in the corresponding location 614 of the output template 600 shown in FIG. 9A. Other responses of output template 600 not corresponding to the patient's response can be deleted.

As a result of the processing described above, the sentence fragment 552 can be inserted into the medical record 305 as part of sentence 556 shown in FIGS. 6 and 7. The generation and insertion of this sentence fragment 552 occurs in response to the patient's entry of the onset response 503 as described above. Next, the patient is prompted to enter the pain response 505. The presentation of the statements/questions related to the pain level of the medical condition in this example occurs because a link in column 446 of the previously selected patient response triggers the next automatically presented question or set of questions. In this case, the input template shown in FIG. 11B at row 448 is triggered as a result of the patient's previous response.

Referring now to FIG. 11B, the patient has previously identified the development of the medical condition as “gradually” in reference to the onset of the medical complaint. Using the link associated with this response as shown in FIG. 11B at column 446, row 447 as described above, the input template shown in FIG. 11B at row 448 can be obtained and used to present questions to the patient that are related to the patient's identified medical complaint. In this example, the patient is presented with the instructions and the statement/question provided in columns 430 and 431 at row 448 as shown in FIG. 11B. The patient is thereby prompted to enter the pain response 505 as needed for sentence fragment 553. In this particular example, the patient selects a response corresponding to “painful” as shown in column 436 at row 448 of FIG. 11B. As a result of this selection, the sentence fragment 553 from column 440 at row 448 of FIG. 11B is retrieved and inserted into the medical record 305 in the “History of Present Illness” section as identified by the information in column 444 of FIG. 11B. Further, the sentence fragment 553 from column 440 at row 448 of FIG. 11B is retrieved and inserted into the medical record 305 at the location, “8076.66” as identified by the information in column 442 at row 448 of FIG. 11B. The insertion of sentence fragment 553 occurs at the location, “8076.66” as identified in the corresponding location 616 of the output template 600 shown in FIG. 9A. Other responses of output template 600 not corresponding to the patient's response can be deleted.

As a result of the processing described above, the sentence fragment 553 can be inserted into the medical record 305 as part of sentence 556 shown in FIGS. 6 and 7. The generation and insertion of this sentence fragment 553 occurs in response to the patient's entry of the pain response 505 as described above. Next, the patient is prompted to enter the frequency response 506. The presentation of the statements/questions related to the frequency of the medical condition in this example occurs because a link in column 446 of the previously selected patient response triggers the next automatically presented question or set of questions. In this case, the input template shown in FIG. 11C at row 449 is triggered as a result of the patient's previous response.

Referring now to FIG. 11C, the patient has previously identified the development of the medical condition as “painful” in reference to the pain level of the medical complaint. Using the link associated with this response as shown in FIG. 11B at column 446, row 448 as described above, the input template shown in FIG. 11C at row 449 can be obtained and used to present questions to the patient that are related to the patient's identified medical complaint. In this example, the patient is presented with the instructions and the statement/question provided in columns 430 and 431 at row 449 as shown in FIG. 11C. The patient is thereby prompted to enter the frequency response 506 as needed for sentence fragment 554. In this particular example, the patient selects a response corresponding to “constant” as shown in column 436 at row 449 of FIG. 11C. As a result of this selection, the sentence fragment 554 from column 440 at row 449 of FIG. 11C is retrieved and inserted into the medical record 305 in the “History of Present Illness” section as identified by the information in column 444 of FIG. 11C. Further, the sentence fragment 554 from column 440 at row 449 of FIG. 11C is retrieved and inserted into the medical record 305 at the location, “8076.68” as identified by the information in column 442 at row 449 of FIG. 11C. The insertion of sentence fragment 554 occurs at the location, “8076.68” as identified in the corresponding location 710 of the output template 600 shown in FIG. 9B. Other responses of output template 600 not corresponding to the patient's response can be deleted.

As a result of the processing described above, the sentence fragment 554 can be inserted into the medical record 305 as part of sentence 556 shown in FIGS. 6 and 7. The generation and insertion of this sentence fragment 554 occurs in response to the patient's entry of the frequency response 506 as described above. Next, the patient is prompted to enter the location response 507. The presentation of the statements/questions related to the location of the medical condition in this example occurs because a link in column 446 of the previously selected patient response triggers the next automatically presented question or set of questions. In this case, the input template shown in FIG. 11C at row 451 is triggered as a result of the patient's previous response.

Referring now to FIG. 11C, the patient has previously identified the development of the medical condition as “constant” in reference to the frequency level of the medical complaint. Using the link associated with this response as shown in FIG. 11C at column 446, row 449 as described above, the input template shown in FIG. 11C at row 451 can be obtained and used to present questions to the patient that are related to the patient's identified medical complaint. In this example, the patient is presented with the instructions and the statement/question provided in columns 430 and 431 at row 451 as shown in FIG. 11C. The patient is thereby prompted to enter the location response 507 as needed for sentence fragment 555. In this particular example, the patient selects a response corresponding to “my right ear” as shown in column 436 at row 451 of FIG. 11C. As a result of this selection, the sentence fragment 555 from column 440 at row 451 of FIG. 11C is retrieved and inserted into the medical record 305 in the “History of Present Illness” section as identified by the information in column 444 of FIG. 11C. Further, the sentence fragment 555 from column 440 at row 451 of FIG. 11C is retrieved and inserted into the medical record 305 at the location, “10016” as identified by the information in column 442 at row 451 of FIG. 11C. The insertion of sentence fragment 555 occurs at the location, “10016” as identified in the corresponding location 712 of the output template 600 shown in FIG. 9B. Other responses of output template 600 not corresponding to the patient's response can be deleted.

As a result of the processing described above, the sentence fragment 555 can be inserted into the medical record 305 as part of sentence 556 shown in FIGS. 6 and 7. The generation and insertion of this sentence fragment 555 occurs in response to the patient's entry of the location response 507 as described above. This completes the compilation of the sentence fragments corresponding to the first sentence 556 of the example medical record 305.

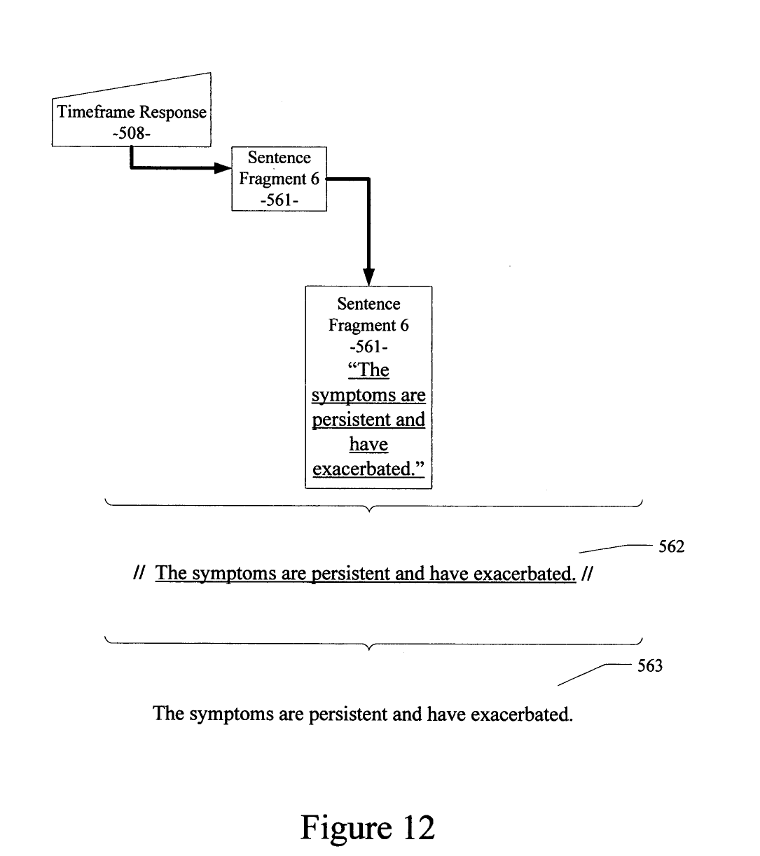

Referring now to FIG. 12, the second sentence 563 of the example medical record 305 is illustrated in relation to the patient input that maps to the automatically generated sentence. In this case, the patient is prompted to enter the timeframe response 508. The presentation of the statements/questions related to the timeframe of the medical condition in this example occurs because a link in column 446 of the previously selected patient response triggers the next automatically presented question or set of questions. In this case, the input template shown in FIG. 11C at row 453 is triggered as a result of the patient's previous response.

Referring now to FIG. 11C, the patient has previously identified the development of the medical condition as involving, “my right ear” in reference to the location of the medical complaint. Using the link associated with this response as shown in FIG. 11C at column 446, row 451 as described above, the input template shown in FIG. 11C at row 453 and 455 can be obtained and used to present questions to the patient that are related to the patient's identified medical complaint. In this example, the patient is presented with the instructions and the statement/question provided in columns 430 and 431 at row 455 as shown in FIG. 11C. The patient is thereby prompted to enter the timeframe response 508 as needed for sentence fragment 561. In this particular example, the patient selects a response corresponding to “my persistent symptoms have worsened” as shown in column 436 at row 453 of FIG. 11C. As a result of this selection, the sentence fragment 561 from column 440 at row 453 of FIG. 11C is retrieved and inserted into the medical record 305 in the “History of Present Illness” section as identified by the information in column 444 of FIG. 11C. Further, the sentence fragment 561 from column 440 at row 453 of FIG. 11C is retrieved and inserted into the medical record 305 at the location, “8126.1” as identified by the information in column 442 at row 453 of FIG. 11C. The insertion of sentence fragment 561 occurs at the location, “8126.1” as identified in the corresponding location 714 of the output template 600 shown in FIG. 9B. Other responses of output template 600 not corresponding to the patient's response can be deleted.

As a result of the processing described above, the sentence fragment 561 can be inserted into the medical record 305 as shown in FIG. 12. The generation and insertion of this sentence fragment 561 occurs in response to the patient's entry of the timeframe response 508 as described above. This completes the compilation of the sentence fragments corresponding to the second sentence 561 of the example medical record 305.

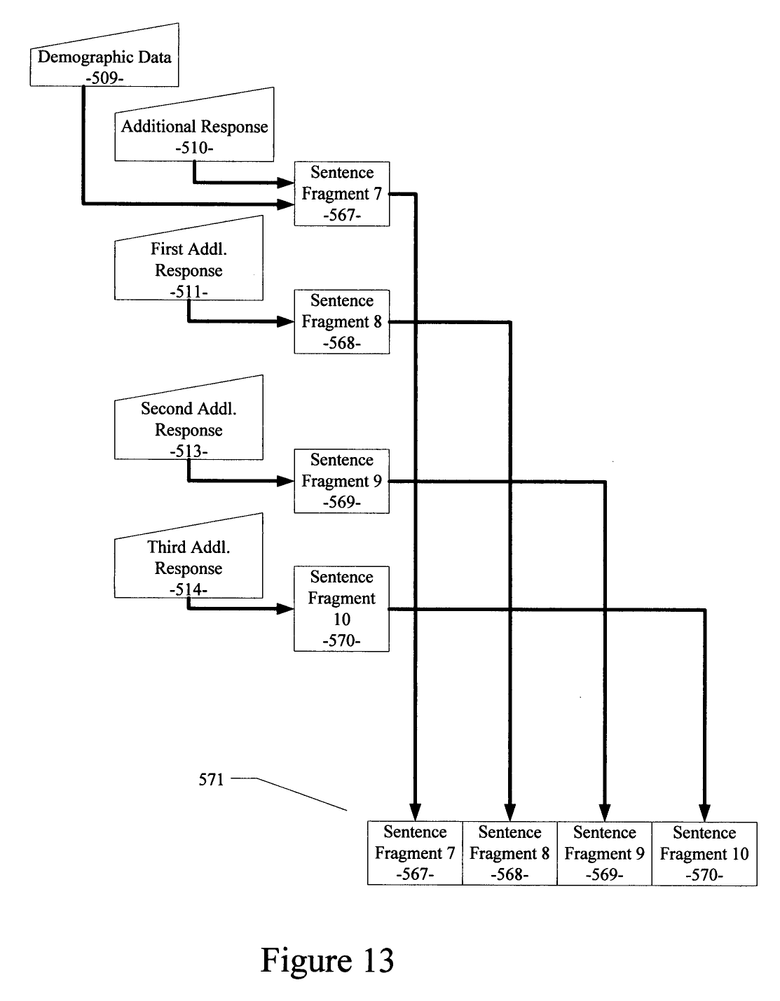

Referring now to FIG. 13, the third sentence 571 of the example medical record 305 is illustrated in relation to the patient input that maps to the automatically generated sentence. In this case, the patient is initially prompted to enter any additional medical conditions as an additional response 510. The presentation of the statements/questions related to any additional medical conditions in this example occurs because a link in column 446 of the previously selected patient response triggers the next automatically presented question or set of questions. In this case, the input template shown in FIG. 11D at row 457 is triggered as a result of the patient's previous response.

Referring now to FIG. 11D, the patient has previously identified the development of the medical condition as, “my persistent symptoms have worsened” in reference to the timeframe response 508 of the medical complaint. Using the link associated with this response as shown in FIG. 11C at column 446, row 453 as described above, the input template shown in FIG. 11D at row 457 can be obtained and used to present questions to the patient that are related to the patient's identified medical complaint. In this example, the patient is presented with the instructions and the statement/question provided in columns 430 and 431 at row 457 as shown in FIG. 11D. The patient is thereby prompted to enter the additional response 510 as needed for sentence fragment 567. In this particular example, the patient selects a response corresponding to “TRUE” as shown in column 436 at row 457 of FIG. 11D. As a result of this selection, the sentence fragment 567 from column 440 at row 457 of FIG. 11D is retrieved and inserted into the medical record 305 in the “History of Present Illness” section as identified by the information in column 444 of FIG. 11D. Further, the sentence fragment 567 from column 440 at row 457 of FIG. 11D is retrieved and inserted into the medical record 305 at the location, “8082” as identified by the information in column 442 at row 457 of FIG. 11D. The insertion of sentence fragment 567 occurs at the location, “8082” as identified in the corresponding location 716 of the output template 600 shown in FIG. 9B. Other responses of output template 600 not corresponding to the patient's response can be deleted.

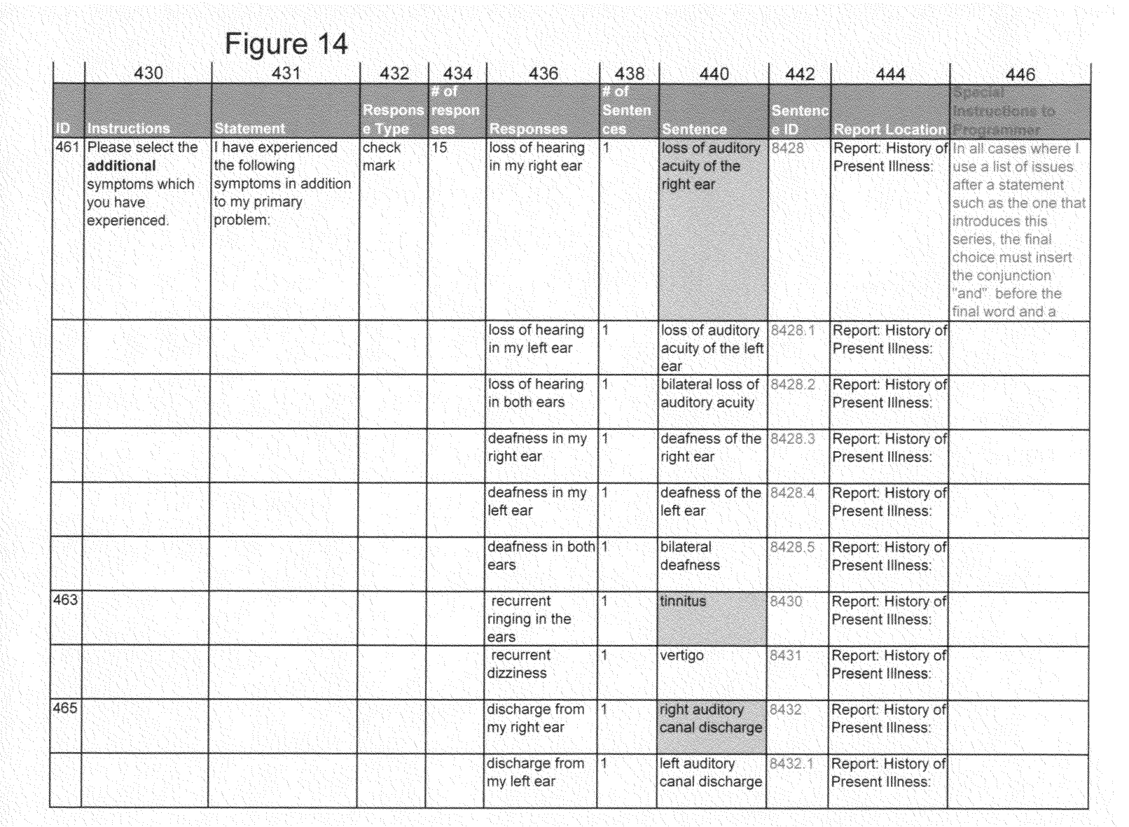

As a result of the processing described above, the sentence fragment 567 can be inserted into the medical record 305 as shown in FIG. 13. The generation and insertion of this sentence fragment 567 occurs in response to the patient's entry of the additional response 510 as described above. Next, the patient is prompted to enter the first additional response 511. The presentation of the statements/questions related to the first additional symptom of the medical condition in this example occurs because a link in column 446 of the previously selected patient response triggers the next automatically presented question or set of questions. In this case, the input template shown in FIG. 14 at row 461 is triggered as a result of the patient's previous response.

Referring now to FIG. 14, the patient has previously identified the development of the medical condition as having additional symptoms. Using the link associated with this response as shown in FIG. 11D at column 446, row 457 as described above, the input template shown in FIG. 14 at row 461 can be obtained and used to present questions to the patient that are related to the patient's identified medical complaint. In this example, the patient is presented with the instructions and the statement/question provided in columns 430 and 431 at row 461 as shown in FIG. 14. The patient is thereby prompted to enter the first additional response 511 as needed for sentence fragment 568. In this particular example, the patient selects a response corresponding to “loss of hearing in my right ear” as shown in column 436 at row 461 of FIG. 14. As a result of this selection, the sentence fragment 568 from column 440 at row 461 of FIG. 14 is retrieved and inserted into the medical record 305 in the “History of Present Illness” section as identified by the information in column 444 of FIG. 14. Further, the sentence fragment 568 from column 440 at row 461 of FIG. 14 is retrieved and inserted into the medical record 305 at the location, “8428” as identified by the information in column 442 at row 461 of FIG. 14. The insertion of sentence fragment 568 occurs at the location, “8428” as identified in the corresponding location 718 of the output template 600 shown in FIG. 9B. Other responses of output template 600 not corresponding to the patient's response can be deleted.

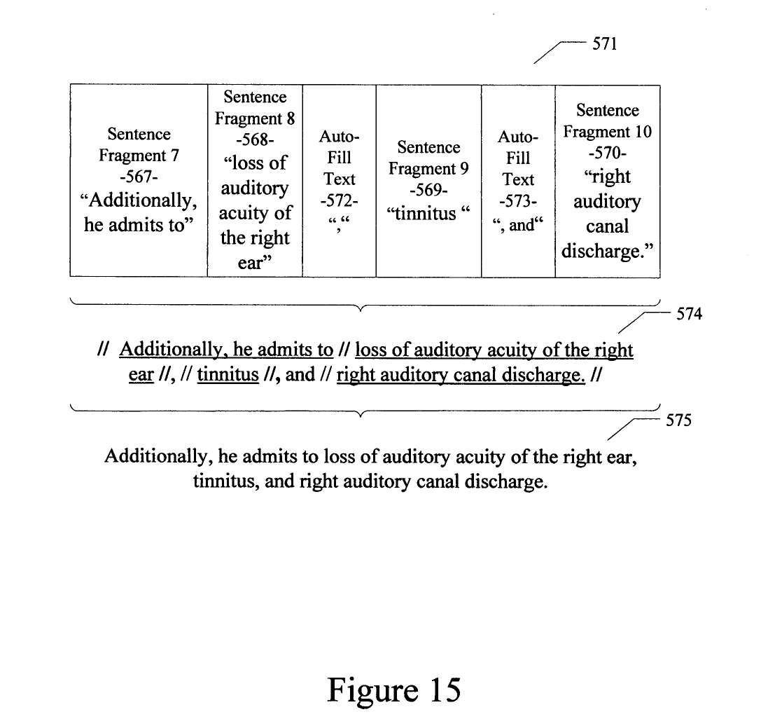

As a result of the processing described above, the sentence fragment 568 can be inserted into the medical record 305 as part of sentence 571 shown in FIGS. 13 and 15. The generation and insertion of this sentence fragment 568 occurs in response to the patient's entry of the first additional response 511 as described above. Next, the patient is prompted to enter the second additional response 513.

Referring now to FIG. 14, the patient is prompted to enter the second additional response 513 as needed for sentence fragment 569. In this particular example, the patient selects a response corresponding to “recurrent ringing in the ears” as shown in column 436 at row 463 of FIG. 14. As a result of this selection, the sentence fragment 569 from column 440 at row 463 of FIG. 14 is retrieved and inserted into the medical record 305 in the “History of Present Illness” section as identified by the information in column 444 of FIG. 14. Further, the sentence fragment 569 from column 440 at row 463 of FIG. 14 is retrieved and inserted into the medical record 305 at the location, “8430” as identified by the information in column 442 at row 463 of FIG. 14. The insertion of sentence fragment 569 occurs at the location, “8430” as identified in the corresponding location 720 of the output template 600 shown in FIG. 9B. Other responses of output template 600 not corresponding to the patient's response can be deleted.

As a result of the processing described above, the sentence fragment 569 can be inserted into the medical record 305 as part of sentence 571 shown in FIGS. 13 and 15. The generation and insertion of this sentence fragment 569 occurs in response to the patient's entry of the second additional response 513 as described above. Next, the patient is prompted to enter the third additional response 514.

Referring now to FIG. 14, the patient is prompted to enter the third additional response 514 as needed for sentence fragment 570. In this particular example, the patient selects a response corresponding to “discharge from my right ear” as shown in column 436 at row 465 of FIG. 14. As a result of this selection, the sentence fragment 570 from column 440 at row 465 of FIG. 14 is retrieved and inserted into the medical record 305 in the “History of Present Illness” section as identified by the information in column 444 of FIG. 14. Further, the sentence fragment 570 from column 440 at row 465 of FIG. 14 is retrieved and inserted into the medical record 305 at the location, “8432” as identified by the information in column 442 at row 465 of FIG. 14. The insertion of sentence fragment 570 occurs at the location, “8432” as identified in the corresponding location 722 of the output template 600 shown in FIG. 9B. Other responses of output template 600 not corresponding to the patient's response can be deleted.

Because the first, second, and third additional responses 511, 513, and 514 are presented to the patient/user as a list, the system of a particular embodiment can automatically insert auto-fill text 572 and 573 into sentence 571 as shown in FIG. 15. In this case, a “,” after sentence fragment 568 and a “, and” can be inserted after sentence fragment 569. This completes the compilation of the sentence fragments corresponding to the third sentence 571 of the example medical record 305.

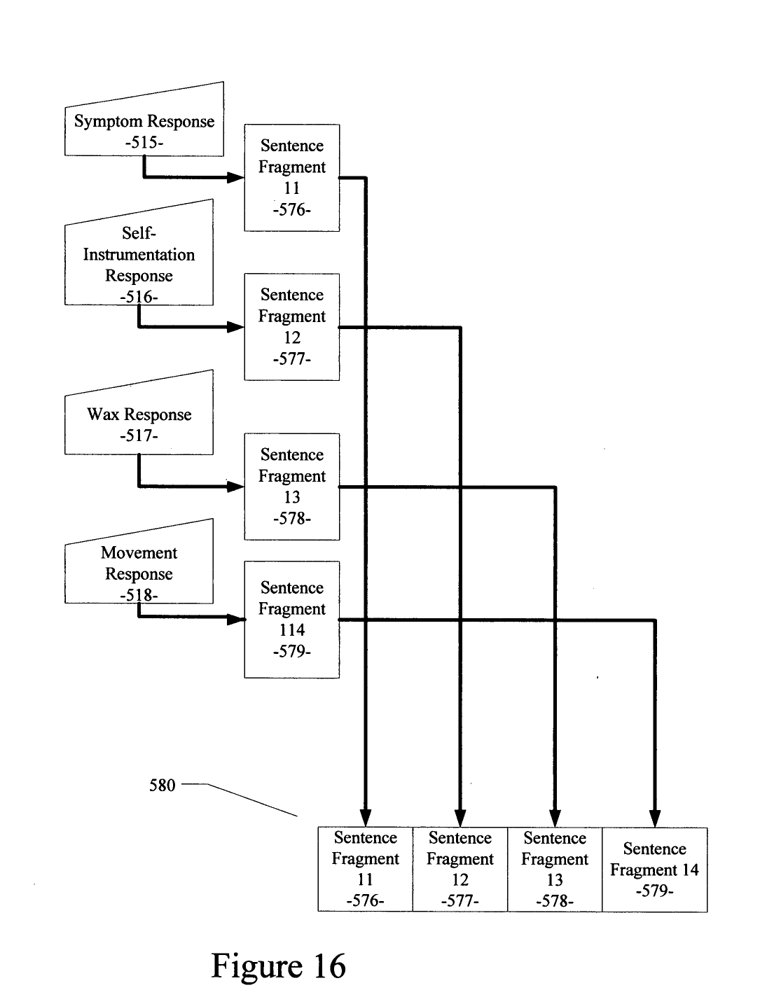

Referring now to FIG. 16, the fourth sentence 580 of the example medical record 305 is illustrated in relation to the patient input that maps to the automatically generated sentence. In this case, the patient is initially prompted to enter any exacerbating medical conditions as symptom response 515. The presentation of the statements/questions related to any exacerbating medical conditions in this example occurs because a link in column 446 of the previously selected patient response triggers the next automatically presented question or set of questions. In this case, the input template shown in FIG. 11E at row 459 is triggered as a result of the patient's previous response.

Referring now to FIG. 11E, using the link associated with the previous response, the input template shown in FIG. 11E at row 459 can be obtained and used to present questions to the patient that are related to the patient's identified medical complaint. In this example, the patient is presented with the instructions and the statement/question provided in columns 430 and 431 at row 459 as shown in FIG. 11E. The patient is thereby prompted to enter the symptom response 515 as needed for sentence fragment 576. In this particular example, the patient selects a response corresponding to “TRUE” as shown in column 436 at row 459 of FIG. 11E. As a result of this selection, the sentence fragment 576 from column 440 at row 459 of FIG. 11E is retrieved and inserted into the medical record 305 in the “History of Present Illness” section as identified by the information in column 444 of FIG. 11E. Further, the sentence fragment 576 from column 440 at row 459 of FIG. 11E is retrieved and inserted into the medical record 305 at the location, “8151” as identified by the information in column 442 at row 459 of FIG. 11E. The insertion of sentence fragment 576 occurs at the location, “8151” as identified in the corresponding location 810 of the output template 600 shown in FIG. 9C. Other responses of output template 600 not corresponding to the patient's response can be deleted.

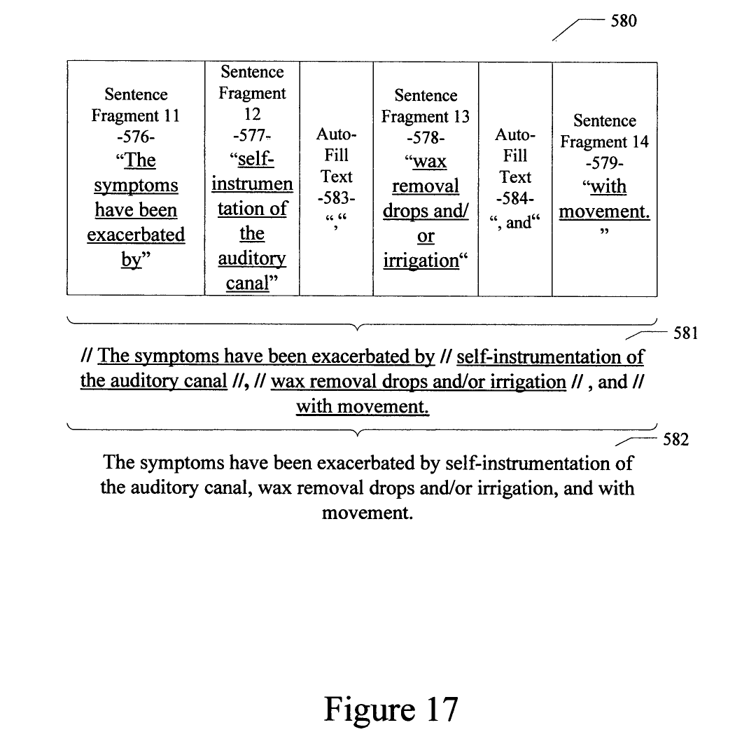

As a result of the processing described above, the sentence fragment 576 can be inserted into the medical record 305 as shown in FIGS. 16 and 17. Similarly, sentence fragments 577, 578, and 579 can be automatically generated based on the inputs 516, 517, and 518, respectively as described in detail above. Thus, sentence 580 can be inserted into the medical record 305 at the appropriate locations as shown in FIG. 9C.

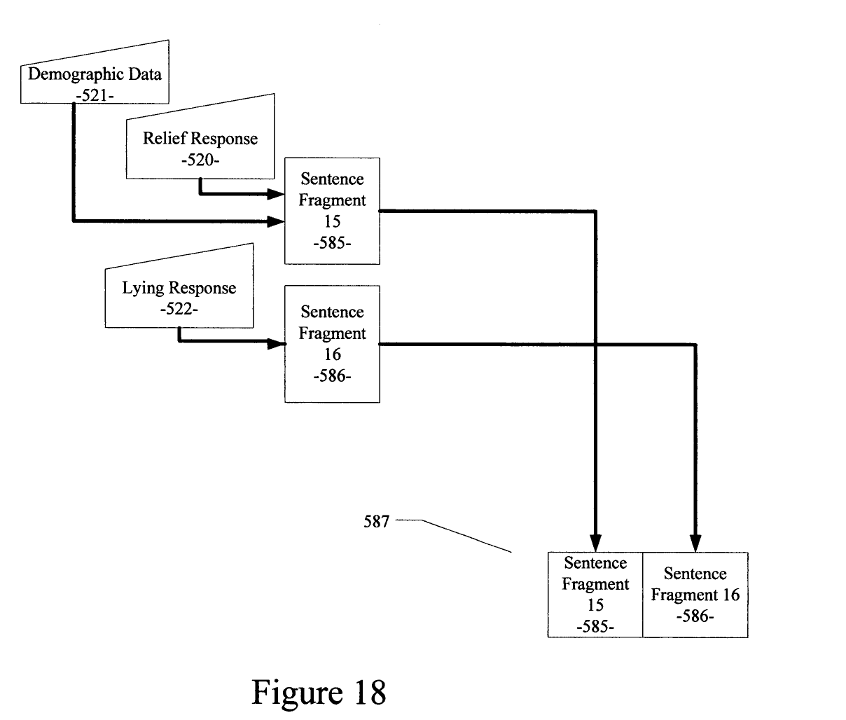

In a manner similar to the processes described above, the remaining sentences 589 and 593 illustrated in FIGS. 18-20 can be automatically generated and inserted into the medical report 305 at the appropriate location.

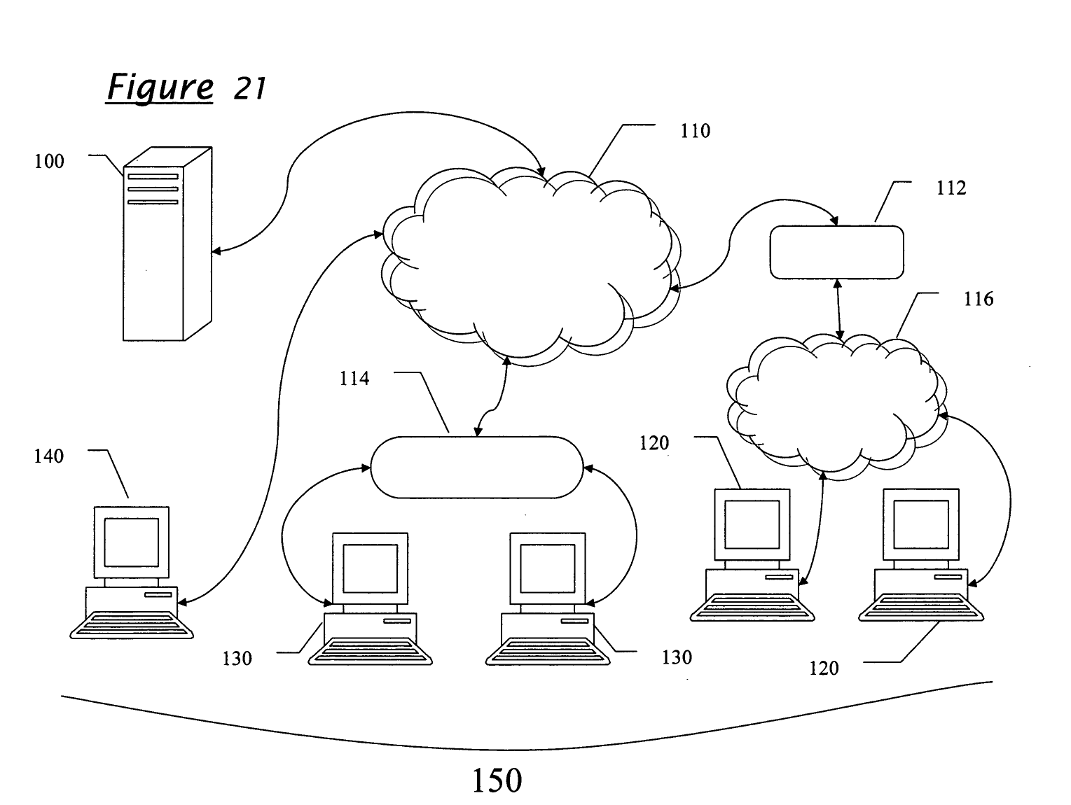

Referring now to FIG. 21, a diagram illustrates the network environment in which various embodiments can operate. In this conventional network architecture, a server computer system 100 is coupled to a wide-area network 110. Wide-area network 110 includes the Internet, or other proprietary networks, which are well known to those of ordinary skill in the art. Wide-area network 110 may include conventional network backbones, long-haul telephone lines, Internet service providers, various levels of network routers, and other conventional means for routing data between computers. Using conventional network protocols, server 100 may communicate through wide-area network 110 to a plurality of client computer systems 120, 130, 140 connected through wide-area network 110 in various ways. For example, client 140 is connected directly to wide-area network 110 through direct or dial-up telephone or other network transmission line. Alternatively, clients 130 may be connected through wide-area network 110 using a modem pool 114. A conventional modem pool 114 allows a plurality of client systems to connect with a smaller set of modems in modem pool 114 for connection through wide-area network 110. In another alternative network topology, wide-area network 110 is connected to a gateway computer 112. Gateway computer 112 is used to route data to clients 120 through a local area network (LAN) 116. In this manner, clients 120 can communicate with each other through local area network 116 or with server 100 through gateway 112 and wide-area network 110.

Using one of a variety of network connection means, server computer 100 can communicate with client computers 150 using conventional means. In a particular implementation of this network configuration, a server computer 100 may operate as a web server if the Internet's World-Wide Web (WWW) is used for wide area network 110. Using the HTTP protocol and the HTML coding language across wide-area network 110, web server 100 may communicate across the World-Wide Web with clients 150. In this configuration, clients 150 use a client application program known as a web browser such as the Internet Explorer™ published by Microsoft Corporation of Redmond, Wash., the user interface of America On-Line™ , or the web browser or HTML renderer of any other supplier. Using such conventional browsers and the World-Wide Web, clients 150 may access image, graphical, and textual data provided by web server 100 or they may run Web application software. Conventional means exist by which clients 150 may supply information to web server 100 through the World Wide Web 110 and the web server 100 may return processed data to clients 150.

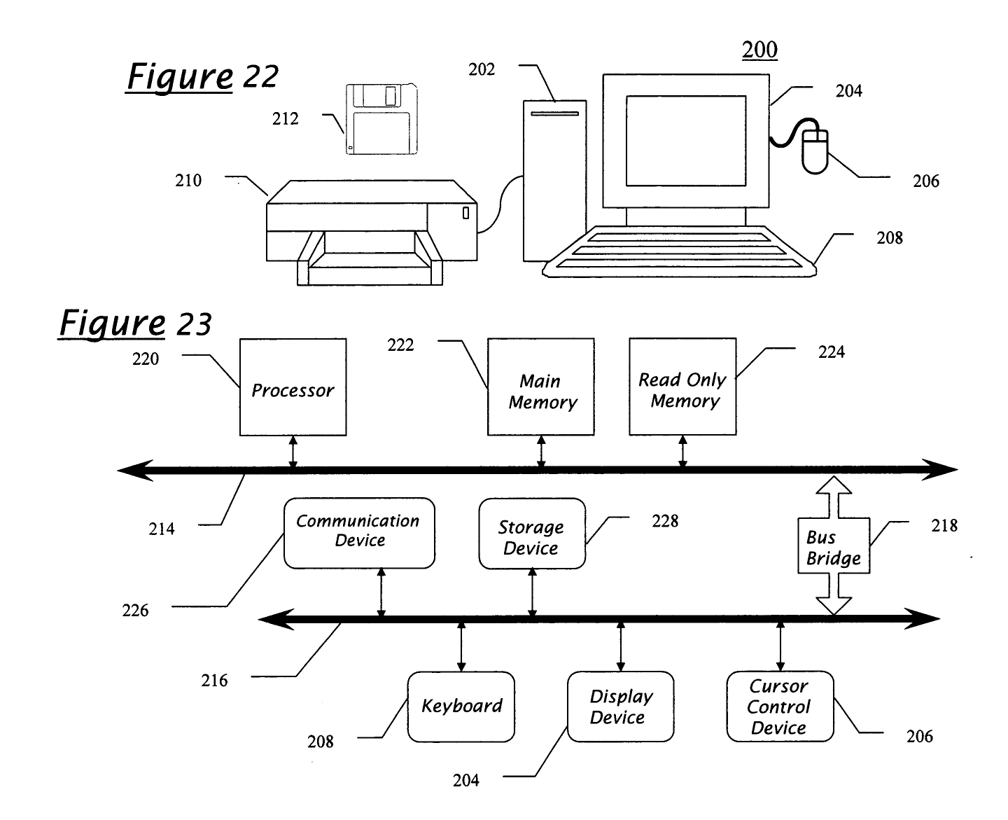

Having briefly described one embodiment of the network environment in which various embodiments may operate, FIGS. 22 and 23 show an example of a computer system 200 illustrating an exemplary host, client, or server computer system, in which the features of an example embodiment may be implemented. Computer system 200 is comprised of a bus or other communications means 214 and 216 for communicating information, and a processing means such as processor 220 coupled with bus 214 for processing information. Computer system 200 further comprises a random access memory (RAM) or other dynamic storage device 222 (commonly referred to as main memory), coupled to bus 214 for storing information and instructions to be executed by processor 220. Main memory 222 also may be used for storing temporary variables or other intermediate information during execution of instructions by processor 220. Computer system 200 also comprises a read only memory (ROM) and/or other static storage device 224 coupled to bus 214 for storing static information and instructions for processor 220.

An optional data storage device 228 such as a magnetic disk or optical disk and its corresponding drive may also be coupled to computer system 200 for storing information and instructions. Computer system 200 can also be coupled via bus 216 to a display device 204, such as a cathode ray tube (CRT) or a liquid crystal display (LCD), for displaying information to a computer user. For example, image, textual, video, or graphical depictions of information may be presented to the user on display device 204. Typically, an alphanumeric input device 208, including alphanumeric and other keys is coupled to bus 216 for communicating information and/or command selections to processor 220. Another type of user input device is cursor control device 206, such as a conventional mouse, trackball, or other type of cursor direction keys for communicating direction information and command selection to processor 220 and for controlling cursor movement on display 204.

Alternatively, the client 280 can be implemented as a network computer or thin client device. Client 280 may also be a laptop or palm-top computing device, such as the Palm Pilot™. Client 280 could also be implemented in a robust cellular telephone, where such devices are currently being used with Internet micro-browsers. Such a network computer or thin client device does not necessarily include all of the devices and features of the above-described exemplary computer system; however, the functionality of an example embodiment or a subset thereof may nevertheless be implemented with such devices.

A communication device 226 is also coupled to bus 216 for accessing remote computers or servers, such as web server 250, or other servers via the Internet, for example. The communication device 226 may include a modem, a network interface card, or other well-known interface devices, such as those used for interfacing with Ethernet, Token-ring or other types of networks. In any event, in this manner, the computer system 200 may be coupled to a number of servers 250 via a conventional network infrastructure such as the infrastructure illustrated and described above.

The system of an example embodiment includes software, information processing hardware, and various processing steps, which are described above. The features and process steps of example embodiments may be embodied in machine or computer executable instructions. The instructions can be used to cause a general purpose or special purpose processor, which is programmed with the instructions to perform the steps of an example embodiment. Alternatively, the features or steps may be performed by specific hardware components that contain hard-wired logic for performing the steps, or by any combination of programmed computer components and custom hardware components. While embodiments are described with reference to the Internet, the method and apparatus described herein is equally applicable to other network infrastructures or other data communications systems.

Various embodiments are described. In particular, the use of embodiments with various types and formats of data structures may be described. It will be apparent to those of ordinary skill in the art that alternative embodiments of the implementations described herein can be employed and still fall within the scope of the claimed invention. In the detail herein, various embodiments are described as implemented in computer-implemented processing logic denoted sometimes herein as the “Software”. As described above, however, the claimed invention is not limited to a purely software implementation.

The software and/or data described herein may further be transmitted or received over a network 280 via a communication device 226 utilizing any one of a number of well-known transfer protocols, for example, the hyper text transfer protocol (HTTP). While the machine-readable medium 212 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that cause the machine to perform any one or more of the methodologies of the disclosed subject matter, or that is capable of storing, encoding, or carrying data structures utilized by or associated with such a set of instructions. The term “machine-readable medium” shall accordingly be taken to include, but not be limited to, solid-state memories, optical and magnetic media, and carrier wave signals.

Although the present specification describes components and functions implemented in the embodiments with reference to particular standards and protocols, the disclosed subject matter may be not limited to such standards and protocols. Each of the standards for Internet and other packet switched network transmission (e.g., TCP/IP, UDP/IP, HTML, and HTTP) represent examples of the state of the art. Such standards are periodically superseded by faster or more efficient equivalents having essentially the same functions. Accordingly, replacement standards and protocols having the same functions are considered equivalents.

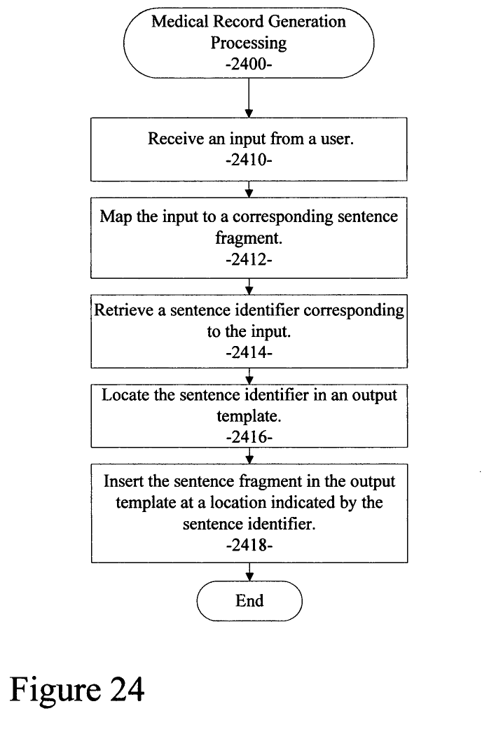

Referring now to FIG. 24, a flow diagram illustrates a processing flow in a particular embodiment. As illustrated, the method in a particular embodiment includes: receiving an input from a user, mapping the input to a corresponding sentence fragment, retrieving a sentence identifier corresponding to the input, locating the sentence identifier in an output template, and inserting the sentence fragment in the output template at a location indicated by the sentence identifier. Details of the method in a particular embodiment are provided above.

Thus, as described above, a system and method for automatically generating grammatically correct electronic medical records is disclosed. Although the disclosed subject matter has been described with reference to several example embodiments, it may be understood that the words that have been used are words of description and illustration, rather than words of limitation. Changes may be made within the purview of the appended claims, as presently stated and as amended, without departing from the scope and spirit of the disclosed subject matter in all its aspects. Although the disclosed subject matter has been described with reference to particular means, materials, and embodiments, the disclosed subject matter is not intended to be limited to the particulars disclosed; rather, the subject matter extends to all functionally equivalent structures, methods, and uses such as are within the scope of the appended claims.

I claim:

1. A method comprising:
receiving an input from a user;
mapping the input to a corresponding sentence fragment;
retrieving a sentence identifier corresponding to the input;
locating the sentence identifier in an output template; and
inserting the sentence fragment in the output template at a location indicated by the sentence identifier.

2. The method as claimed in claim 1 further including retrieving a link corresponding to the input, the link being indicative of a next input prompt.

3. The method as claimed in claim 1 wherein the input is received via a website user interface.

4. The method as claimed in claim 1 wherein the input is received from a patient.

5. The method as claimed in claim 1 further including retrieving a document identifier corresponding to the input.

6. The method as claimed in claim 1 wherein the insertion of the sentence fragment in the output template creates a portion of a medical record.

7. The method as claimed in claim 6 wherein the medical record is one or more of: a medical history, a surgical record, a mental health record, hospital record, counseling record, coaching record, physical therapy record, mental therapy record, and behavioral therapy record.

8. The method as claimed in claim 1 further including inserting auto-fill text in the output template.

9. The method as claimed in claim 1 further including mapping a second input to a corresponding second sentence fragment, the sentence fragment and the second sentence fragment being combined in the output template to form a complete sentence.

10. The method as claimed in claim 1 further including mapping a second input to a corresponding second sentence fragment, the sentence fragment, auto-fill text, and the second sentence fragment being combined in the output template to form a complete sentence.

11. A system comprising:
a processor;
a memory coupled to the processor to store information related to medical records;
an input component to receive an input from a user, to map the input to a corresponding sentence fragment, and to retrieve a sentence identifier corresponding to the input; and
an output component to locate the sentence identifier in an output template, and to insert the sentence fragment in the output template at a location indicated by the sentence identifier.

12. The system as claimed in claim 11 being further configured to retrieve a link corresponding to the input, the link being indicative of a next input prompt.

13. The system as claimed in claim 11 wherein the input is received via a website user interface.

14. The system as claimed in claim 11 wherein the input is received from a patient.

15. The system as claimed in claim 11 being further configured to retrieve a document identifier corresponding to the input.

16. The system as claimed in claim 11 wherein the insertion of the sentence fragment in the output template creates a portion of a medical record.

17. The system as claimed in claim 16 wherein the medical record is one or more of: a medical history, a surgical record, a mental health record, hospital record, counseling record, coaching record, physical therapy record, mental therapy record, and behavioral therapy record.

18. The system as claimed in claim 11 being further configured to insert auto-fill text in the output template.

19. The system as claimed in claim 11 being further configured to map a second input to a corresponding second sentence fragment, the sentence fragment and the second sentence fragment being combined in the output template to form a complete sentence.

20. The system as claimed in claim 11 being further configured to map a second input to a corresponding second sentence fragment, the sentence fragment, auto-fill text, and the second sentence fragment being combined in the output template to form a complete sentence.

21. An article of manufacture comprising a machine-readable medium having machine executable instructions embedded thereon, which when executed by a machine, cause the machine to:
receive an input from a user;
map the input to a corresponding sentence fragment;
retrieve a sentence identifier corresponding to the input;
locate the sentence identifier in an output template; and
insert the sentence fragment in the output template at a location indicated by the sentence identifier.

22. The article of manufacture as claimed in claim 21 being further configured to retrieve a link corresponding to the input, the link being indicative of a next input prompt.

23. The article of manufacture as claimed in claim 21 wherein the input is received via a website user interface.

24. The article of manufacture as claimed in claim 21 wherein the input is received from a patient.

25. The article of manufacture as claimed in claim 21 being further configured to retrieve a document identifier corresponding to the input.

26. The article of manufacture as claimed in claim 21 wherein the insertion of the sentence fragment in the output template creates a portion of a medical record.

27. The article of manufacture as claimed in claim 26 wherein the medical record is one or more of: a medical history, a surgical record, a mental health record, hospital record, counseling record, coaching record, physical therapy record, mental therapy record, and behavioral therapy record.

28. The article of manufacture as claimed in claim 21 being further configured to insert auto-fill text in the output template.

29. The article of manufacture as claimed in claim 21 being further configured to map a second input to a corresponding second sentence fragment, the sentence fragment and the second sentence fragment being combined in the output template to form a complete sentence.

30. The article of manufacture as claimed in claim 21 being further configured to map a second input to a corresponding second sentence fragment, the sentence fragment, auto-fill text, and the second sentence fragment being combined in the output template to form a complete sentence.
